(19) United States
(12) Patent Application Publication
(10) Pub. No.: US 2026/0286052 A1
(43) Pub. Date: Sep. 24, 2026

(54) TWO-COMPONENT POLYURETHANE COMPOSITIONS AND METHODS OF MAKING THE SAME

(71) Applicant: INGEVITY UK LTD, Cheshire (GB)

(72) Inventors: Anthony Maher, Cheshire (GB); Shaun Birss, Cheshire (GB); Sarah Findlater, Cheshire (GB)

(21) Appl. No.: 19/346,345

(22) Filed: Sep. 30, 2025

Related U.S. Application Data
(60) Provisional application No. 63/776,340, filed on Mar. 24, 2025.

(51) Int. Cl. C08G 71/04; C09D 175/08

(52) U.S. Cl. CPC C08G 71/04; C09D 175/08

(57) ABSTRACT

The present disclosure provides a two-component thermoset polyurethane or two-component thermoset polyurethane composition that includes one or more polycaprolactone including (i) one or more unsubstituted or substitute caprolactone monomer, and (ii) an initiator including at least one primary hydroxyl group and at least one secondary hydroxyl group, wherein the polycaprolactone has an average molecular weight of about 240 g/mol to about 10,000 g/mol. The disclosure further provides methods of making the two-component thermoset polyurethane, and using the same.

### CROSS-REFERENCE TO RELATED APPLICATIONS

This application claims priority to, and the benefit of, U.S. Provisional Patent Application No. 63/776,340, filed 24 Mar. 2025, which is incorporated by reference in its entirety for all purposes.

### BACKGROUND

Field of the Discovery. The present disclosure relates to two-component thermoset polyurethane compositions with improved flexibility and processing characteristics, and methods for preparing and using the same.

Background Information Polycaprolactones are a unique class of polyester polyol that are used, e.g., in the production of polyurethane materials. Polyurethanes based on polycaprolactones are characterized by best-in-class mechanical properties, outstanding durability in harsh environmental conditions, and processing ease, as compared to many alternative materials. For this reason, polycaprolactones find use in very demanding applications where articles are exposed to high temperatures, humid environments, ultraviolet (UV) light, and repeated mechanicals deformations, such as in industrial seals, gaskets, wheels and rollers, paint protection films, and in automotive suspension systems.

Considering escalating environmental and regulatory concerns, it is imperative to maintain vigilance regarding the raw materials employed in polymers. The health and safety impacts of these materials are of paramount importance. Trimethylolpropane (TMP), a material traditionally utilized in a broad spectrum of industrial applications that includes the manufacture of polyols, has come under scrutiny due to potential reprotoxic effects.

However, due to the regulatory position of trimethylolpropane (TMP) being reclassified as a reproductive toxicant, an alternative initiator is required for production of polycaprolactones for use in urethane compositions.

There exists a need for thermoset polyurethane compositions prepared from safe raw materials, while maintaining performance characteristics. The present disclosure addresses these needs with novel two-component thermoset polyurethane compositions.

### SUMMARY

Surprisingly and unexpectedly, it was discovered that the two-component thermoset polyurethane or two-component thermoset polyurethane compositions of the present disclosure are both effective and safe for users and the environmental. The two-component thermoset polyurethane compositions of the present disclosure have improved processability at room temperature, lower viscosity, improved flexibility through the use of the polycaprolactone or polycaprolactone compositions of the present disclosure, as compared to two-component thermoset polyurethane prepared with a comparable polycaprolactone (e.g., polycaprolactones with equivalent functionality and molecular weight, reacted with an equivalent isocyante, at equivalent index and OH value). The use of the polycaprolactone of the present disclosure provides the technical benefits of polycaprolactones, while avoiding the use of a reproductive toxicant trimethylolpropane (TMP).

An aspect of the present disclosure provides a two-component thermoset polyurethane comprising one or more (e.g., 1, 2, 3, 4, or more) polycaprolactone (e.g., polycaprolactone polyol or triol) comprising, consisting essentially of, or consisting of, (i) one or more (e.g., 1, 2, 3, 4, or more) unsubstituted or substitute caprolactone monomers (e.g., ε-caprolactone), and (ii) an initiator comprising, or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

An further aspect of the present disclosure provides a two-component thermoset polyurethane comprising one or more (e.g., 1, 2, 3, 4, or more) polycaprolactone (e.g., polycaprolactone polyol or triol) comprising, consisting essentially of, or consisting of, (i) three caprolactone polymers attached to (ii) an initiator comprising, or consisting essentially of, at least (e.g., 1 or 2) one primary hydroxyl group (e.g., two primary hydroxyl groups) and at least one (e.g., 1 or 2) secondary hydroxyl group (e.g., one secondary hydroxyl group), wherein each of the three caprolactone polymers is independently comprising, consisting essentially of, or consisting of, one or more (e.g., 1, 2, 3, 4, or more) unsubstituted or substitute caprolactone monomers (e.g., ε-caprolactone).

An aspect of the present disclosure provides a two-component thermoset polyurethane comprising a polycaprolactone composition (e.g., a polycaprolactone polyol or triol composition) comprising, consists essentially of, or consists of, a polycaprolactone (e.g., polycaprolactone polyol or triol) comprising, consists essentially of, or consists of, a reaction product of (i) one or more (e.g., 1, 2, 3, 4, or more) unsubstituted or substitute caprolactone monomer (e.g., ε-caprolactone), and (ii) an initiator comprising or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein: the one or more caprolactone monomer is present in the range of about 5.0 wt % to about 99.0 wt % of the total molecular weight of the polycaprolactone composition, the initiator is present in the range of about 1.0 wt % to about 95.0 wt % of the total molecular weight of the polycaprolactone composition, and the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

Another aspect of the present disclosure provides a method of making or producing the two-component thermoset polyurethane composition of the present disclosure, the method comprising, consisting essentially of, or consists of, reacting the one or more polycaprolactone or polycaprolactone composition or the polyol resin of the present disclosure, the one or more polyisocyanate (e.g., one or more diisocyanate), optionally the one or more additional polyol, and optionally the one or more chain extender.

An additional aspect of the present disclosure provides a two-component thermoset polyurethane composition of the present disclosure made by a process comprising or consisting essentially of, or consists of, reacting: (a) the one or more polycaprolactone or polycaprolactone composition or the polyol resin of the present disclosure; (b) optionally, one or more (e.g., 1, 2, 3, 4, 5, or more) additional polyol; (c) one or more (e.g., 1, 2, 3, 4, 5, or more) polyisocyanate comprising two or more isocyanate groups (e.g., one or more diisocyanate); (d) optionally, one or more (e.g., 1, 2, 3, 4, 5, or more) defoamer (e.g., at least one of silicone defoamer, polysiloxane defoamer, or a combination thereof); (e) optionally, one or more (e.g., 1, 2, 3, 4, 5, or more) surface additive (e.g., silicone-containing surface additive); (f) optionally, one or more (e.g., 1, 2, 3, 4, 5, or more) solvent (e.g., at least one of butyl acetate, xylene, methoxy propyl acetate, or a combination thereof); and (g) one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a two-component thermoset polyurethane material or composition.

A further aspect of the present disclosure provides a method of making or producing the two-component thermoset polyurethane composition of the present disclosure, the method comprising, consisting essentially of, or consists of, reacting: (a) the one or more polycaprolactone or polycaprolactone composition or polyol resin of the present disclosure; (b) optionally, one or more (e.g., 1, 2, 3, 4, 5, or more) additional polyol; (c) one or more (e.g., 1, 2, 3, 4, 5, or more) polyisocyanate comprising two or more isocyanate groups (e.g., one or more diisocyanate); (d) optionally, one or more (e.g., 1, 2, 3, 4, 5, or more) defoamer (e.g., at least one of silicone defoamer, polysiloxane defoamer, or a combination thereof); (e) optionally, one or more (e.g., 1, 2, 3, 4, 5, or more) surface additive (e.g., silicone-containing surface additive); (f) optionally, one or more (e.g., 1, 2, 3, 4, 5, or more) solvent (e.g., at least one of butyl acetate, xylene, methoxy propyl acetate, or a combination thereof); and (g) one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a two-component thermoset polyurethane material or composition.

Another aspect of the present disclosure provides a polyurethane dispersion in aqueous or organic media, a two-component polyurethane coating, or a two-component thermoset polyurethane sealant, comprising, consisting essentially of, or consisting of, the two-component thermoset polyurethane composition of the present disclosure, or a two-component thermoset polyurethane composition prepared according to the method of the present disclosure.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating an embodiment of the disclosure and are not to be construed as limiting the disclosure. Further objects, features and advantages of the disclosure will become apparent from the following detailed description taken in conjunction with the accompanying figures showing illustrative embodiments of the disclosure.

FIG. 1: Formulation volatile organic compound impact analysis.

FIG. 2: Viscosity Sweep of the 300MW polycaprolactone triols, 25-85° C.

FIG. 3: Viscosity Sweep of the 500MW polycaprolactone triols, 25-85° C.

FIG. 4: Dry time determination of the PU1 polyurethane formulations.

FIG. 5: Oscillation counts of König pendulum hardness for PU1 polyurethane formulations.

FIG. 6: Oscillation counts of Konig pendulum hardness for PU2 polyurethane formulations.

FIG. 7: Taber Wear Index (TWI) of the PU1 polyurethane formulations after 500 cycles of Taber abrasion testing.

FIG. 8: Abrasion and Self-Heal results of the PU1 polyurethane formulations comprising 200 MW polycaprolactone triols, after 3 testing cycles.

FIG. 9: Abrasion and Self-Heal results of the PU1 polyurethane formulations comprising 500 MW polycaprolactone triols, after 3 testing cycles.

FIG. 10: Glass transition temperature for PU1 polyurethane formulations.

FIG. 11: Cross link density for PU1 polyurethane formulations.

### DETAILED DESCRIPTION OF THE INVENTION

Presently described are two-component thermoset polyurethane compositions with improved processability at room temperature, lower viscosity, improved flexibility through the use of the polycaprolactone or polycaprolactone compositions of the present disclosure, as compared to two-component thermoset polyurethane prepared with a comparable polycaprolactone (e.g., polycaprolactones with equivalent functionality and molecular weight, reacted with an equivalent isocyanate, at equivalent index and OH value). The use of the polycaprolactone of the present disclosure provides the technical benefits of polycaprolactones while avoiding the use of a reproductive toxicant trimethylolpropane (TMP).

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value in the range, to the tenth of the unit of the lower limit unless the context clearly dictates otherwise (e.g., in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either/or both of those included limits are also included in the disclosure.

It should also be understood that, in certain methods or processes described herein that include more than one step or act, the order of the steps or acts of the method is not necessarily limited to the order in which the steps or acts of the method are recited unless the context indicates otherwise.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (that is, to at least one or one or more of) of the grammatical object of the article unless the context clearly indicates otherwise. By way of example, “an element” means one element or more than one element, unless otherwise indicated.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, that is, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (that is, “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting (e.g., “consisting essentially of” or “consisting of”), unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

The term “independently” is used herein to indicate that the variable, which is independently applied, varies independently from application to application.

The term “optional” or “optionally”, as used herein, means that the subsequently described event or circumstance may or may not occur, and that the description includes instances where said event or circumstance occurs and instances where it does not.

The term The term “substituted” or “optionally substituted”, as used herein, means that any one or more (e.g., 1, 2, 3, 4, 5, 6, 7, 8, 9, or more) hydrogens on the designated atom or group is replaced (e.g., replaced with a selection from an indicated group) provided that the designated atom's normal valence is not exceeded. For example, when the substituent is oxo (that is, ═O) then two hydrogens on the atom are replaced. When an oxo group substitutes a heteroaromatic moiety, the resulting molecule can sometimes adopt tautomeric forms. For example, a pyridyl group substituted by oxo at the 2-position or 4-position can sometimes be written as a pyridine or hydroxypyridine. Combinations of substituents and/or variables are permissible only if such combinations result in stable compounds or useful synthetic intermediates. A stable compound or stable structure is meant to imply a compound that is sufficiently robust to survive isolation from a reaction mixture and subsequent formulation. In any aspect or embodiment described herein, substituted (e.g., an optionally substituted) is one or more independently selected substituents (e.g., at least one of 0 substituents, 1 substituent, 2 substituents, 3 substituents, 4 substituents, 5 substituents, or a combination thereof) on any atom (e.g., a carbon or nitrogen atom) of the element or moiety that is substituted and may include substituents, which themselves may be optionally substituted, as described herein, at an atom located on the element, moiety, or compound that is substituted. For example, in any aspect or embodiment described herein, each substitution or substituent is independently selected from hydroxyl (—OH), C₁₋₁₀ thiol (e.g., C₁₋₆ thiol or C₁₋₃ thiol), carboxyl (—COOH), cyano (—CN), nitro (—NO₂), imino (═NH), halogen (e.g., F, Cl, Br, I, and/or 1, 2 or 3 halogens, especially on an alkyl group, including a methyl group (e.g., trifluoromethyl)), a C₁₋₁₀ alkyl (e.g., C₁₋₆ alkyl or C₁₋₃ alkyl), a C₁₋₁₀ alkenyl (e.g., C₁₋₆ alkenyl or C₁₋₃ alkenyl), a C₁₋₁₀ alkynyl (e.g., C₁₋₆ alkynyl or C₁₋₃ alkynyl), aryl (e.g., a 6-, 7-, 8-, 9-, or 10-membered aryl), heteroaryl (e.g., a 5-, 6-, 7-, 8-, 9-, or 10-membered aryl), cycloalkyl (e.g., a 3-, 4-, 5-, 6-, 7-, 8-, 9-, or 10-membered cycloalkyl), heterocycloalkyl (e.g., a 3-, 4-, 5-, 6-, 7-, 8-, 9-, or 10-membered heterocycloalkyl), C₁₋₁₀ alkoxy (e.g., C₁₋₆ alkoxy or C₁₋₃ alkoxy), C₁₋₁₀ thioether (e.g., C₁₋₆ thioether or C₁₋₃ thioether), C₁₋₁₀ acyl (e.g., C₁₋₆ acyl or C₁₋₃ acyl), C₁₋₁₀ ester (e.g., C₁₋₆ ester, C₁₋₃ ester, and/or for example, C₁₋₆, or C₁₋₃ ester alkylene ester), C₁₋₁₀ thioester (e.g., C₁₋₆ thioester, C₁₋₃ thioester, optionally substituted amino (e.g., —NH₂, C₁₋₆ alkyl amine, C₁₋₆ dialkyl amine, —C₁₋₆ alkylene-NR1R2, or —(CH₂)ₘ—NR1R2, wherein m is 0, 1, 2, 3, 4, 5, 6, 7, 8, 9, or 10, and R1 and R2 are independently H or C₁₋₆ alkyl group, optionally substituted with one or more groups (e.g., 1, 2, 3, 4, or 5 groups) independently selected from hydroxyl and halogen (e.g., F, Br, Cl, or I)), —(CH₂)ₘCOOH (wherein m is 0, 1, 2, 3, 4, 5, 6, 7, 8, 9, or 10), —(CH₂)ₘOH (wherein m is 0, 1, 2, 3, 4, 5, 6, 7, 8, 9, or 10), hydrazine, optionally substituted amido (—CO—NH₂) (e.g., optionally substituted with one or two independently selected C₁₋₆ C₁₋₃ alkyl groups, C₁₋₁₀ alkanol (e.g., C₁₋₆ alkanol or C₁₋₃ alkanol), C₁₋₁₀ alkanoic acid (e.g., C₁₋₆ alkanoic acid or C₁₋₃ alkanoic acid). “unsubstituted” shall mean substituted only with hydrogen atoms.

As used herein, the term “caprolactone” is intended to encompass unsubstituted caprolactone and substituted caprolactone. The term “ε-caprolactone” is intended to encompass unsubstituted ε-caprolactone and substituted ε-caprolactone. Unsubstituted ε-caprolactone is particularly preferred.

In any aspect or embodiment described herein, substituted ε-caprolactone monomers that may be used in the production of the caprolactone polyols include C₁₋₁₂ alkyl substituted ε-caprolactone, alkenyl substituted ε-caprolactone (e.g., C₂₋₁₂ alkenyl substituted ε-caprolactone), alkynyl substituted ε-caprolactone (e.g., C₂₋₁₂ alkynyl substituted ε-caprolactone), cycloalkyl substituted ε-caprolactone (e.g., C₁₋₁₈ cycloalkyl substituted ε-caprolactone), alkoxy substituted ε-caprolactone (e.g., C₁₋₁₂alkoxy substituted ε-caprolactone), aryl substituted ε-caprolactone (e.g., C₁₋₁₈ aryl substituted ε-caprolactone), alkaryl substituted ε-caprolactone (e.g., C₁₋₁₈ alkaryl substituted ε-caprolactone), aralkyl substituted ε-caprolactone (e.g., C₁₋₁₈ aralkyl substituted ε-caprolactone), aryloxy substituted ε-caprolactone (e.g., C₁₋₁₈ aryloxy substituted ε-caprolactone), and mixtures thereof.

In any aspect or embodiment described herein, substituted ε-caprolactone monomers that may be used in the production of the polycaprolactones include mono-, di- or tri-substituted monomers. In any aspect or embodiment described herein, exemplary substituted ε-caprolactone monomers include monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl ε-caprolactone, dipropyl ε-caprolactone, dimethoxy ε-caprolactone, diethoxy ε-caprolactone, dipropoxy ε-caprolactone, dibenzyl ε-caprolactone, diphenyl ε-caprolactone, and mixtures thereof.

The term “alkyl” shall mean within its context a linear, branch-chained or cyclic fully saturated hydrocarbon radical, such as a C₁-C₁₅, a C₁-C₁₂, a C₁-C₁₀, a C₁-C₆, a C₁-C₅, or a C₁-C₃ alkyl group, which is optionally substituted with any suitable functional group or groups (e.g., optionally substituted as described herein). Examples of alkyl groups are methyl, ethyl, butyl, n-butyl, sec-butyl, pentyl, hexyl, n-hexyl, n-heptyl, n-octyl, n-nonyl, n-decyl, isopropyl, 2-methylpropyl, cyclopropyl, cyclopropylmethyl, cyclobutyl, cyclopentyl, cyclopentylethyl, cyclohexyl, cyclohexylethyl and cyclohexyl, among others.

The term “alkenyl” refers to a linear, branch-chained, or cyclic C₂-C₁₂ (e.g., C₂-C₁₀ or C₂-C₆) hydrocarbon radicals containing at least one C═C bond, which is optionally substituted with any suitable functional group or groups (e.g., optionally substituted as described herein).

The term “alkynyl” refers to linear, branch-chained, or cyclic C₂-C₁₂ (e.g., C₂-C₁₀ or C₂-C₆) hydrocarbon radicals containing at least one C≡C bond, which is optionally substituted with any suitable functional group or groups (e.g., optionally substituted as described herein).

The term “cycloalkyl” refers to a univalent saturated, monocyclic hydrocarbon ring or saturated, polycyclic hydrocarbon fused ring system, wherein each ring is independently a 3-, 4-, 5-, 6-, 7-, 8-, 9-, 10-, 11-, 12-, 13-, 14-, 15-, 16-, 17-, 18-, 19-, or 20-member ring (e.g., each ring is independently cyclopropyl, cyclobutyl, cyclopentyl, cyclohexyl, or cycloheptyl), and is optionally substituted with any suitable functional group or groups (e.g., optionally substituted as described herein).

The term “alkoxy” shall mean an alkyl group, as defined herein, with the indicated number of carbon atoms covalently bound to the group it substitutes by an oxygen bridge (—O—), which is optionally substituted with any suitable functional group or groups (e.g., optionally substituted as described herein). Examples, in any aspect or embodiment described herein, the alkoxy groups include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, or 3-methylpentoxy.

The term “aryl” refers to a substituted (i.e., substituted with any suitable functional group or groups (e.g., optionally substituted as described herein)) or unsubstituted monovalent aromatic radical (e.g., a 5-, 6-, 7-, 8-, 9-, 10-, 11-, 12-, 13-, 14-, 15-, or 16-membered ring) having a single ring (e.g., benzene, phenyl, benzyl, or 5-, 6-, 7-, 8-, 9-, or 10-membered ring) or condensed rings (e.g., naphthyl, anthracenyl, phenanthrenyl, 10-, 11-, 12-, 13-, 14-, 15-, or 16-membered ring, etc.) and can be bound to the parent moiety at any available stable position on the ring(s) or as otherwise indicated in the chemical structure presented.

The term “alkaryl” refers to a group that comprises an aryl and one or more alkyl attached to the aryl, which is optionally substituted with any suitable functional group or groups (e.g., optionally substituted as described herein), wherein the aralkyl is attached to the parent moiety through an alkyl group.

The term “aralkyl” refers to a group that comprises an aryl and one or more alkyl attached to the aryl, which is optionally substituted with any suitable functional group or groups (e.g., optionally substituted as described herein), wherein the aralkyl is attached to the parent moiety through the aryl.

The term “aryloxy” refers to a group that comprises an aryl and one or more alkoxy attached to the aryl, which is optionally substituted with any suitable functional group or groups (e.g., optionally substituted as described herein), wherein the aryloxy is attached to the parent moiety through the aryl.

### Two-Component Thermoset Polyurethane and Methods of Making the Same

An aspect of the present disclosure provides two-component thermoset polyurethane comprising one or more (e.g., 1, 2, 3, 4, or more) polycaprolactone (e.g., polycaprolactone polyol or triol) comprising, consisting essentially of, or consisting of, (i) one or more (e.g., 1, 2, 3, 4, or more) unsubstituted or substitute caprolactone monomers (e.g., ε-caprolactone), and (ii) an initiator comprising, or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

Another aspect of the present disclosure provides a two-component thermoset polyurethane comprising one or more (e.g., 1, 2, 3, 4, or more) polycaprolactone (e.g., polycaprolactone polyol or triol) comprising, consisting essentially of, or consisting of, (i) three caprolactone polymers attached to (ii) an initiator comprising, or consisting essentially of, at least (e.g., 1 or 2) one primary hydroxyl group (e.g., two primary hydroxyl groups) and at least one (e.g., 1 or 2) secondary hydroxyl group (e.g., one secondary hydroxyl group), wherein each of the three caprolactone polymers is independently comprising, consisting essentially of, or consisting of, one or more (e.g., 1, 2, 3, 4, or more) unsubstituted or substitute caprolactone monomers (e.g., ε-caprolactone).

In any aspect or embodiment described herein, the three caprolactone polymers are attached to the initiator via an oxygen of the initiator. For example, in any aspect or embodiment described herein, the polycaprolactone has the chemical structure:

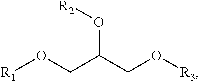

wherein each of R1, R2, and R3 are independently a caprolactone polymers is independently comprising, consisting essentially of, or consisting of, one or more (e.g., 1, 2, 3, 4, or more) unsubstituted or substitute caprolactone monomers (e.g., ε-caprolactone).

A further aspect of the present disclosure provides a two-component thermoset polyurethane comprising a polycaprolactone composition (e.g., a polycaprolactone polyol or triol composition) comprising, consists essentially of, or consists of, a polycaprolactone (e.g., polycaprolactone polyol or triol) comprising, consists essentially of, or consists of, a reaction product of (i) one or more (e.g., 1, 2, 3, 4, or more) unsubstituted or substitute caprolactone monomer (e.g., ε-caprolactone), and (ii) an initiator comprising or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein: (a) the one or more caprolactone monomer is present in the range of about 5.0 wt % to about 99.0 wt % of the total molecular weight of the polycaprolactone composition, (b) the initiator is present in the range of about 1.0 wt % to about 95.0 wt % of the total molecular weight of the polycaprolactone composition, and, and (c) the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

A further aspect of the present disclosure provides a two-component thermoset polyurethane composition comprising, consisting essentially of, or consists of a reaction product of: (a) the one or more (e.g., 1, 2, 3, 4, or more) polycaprolactone or polycaprolactone composition that is present in the range of about 5.0 wt % to about 95.0 wt % of the two-component thermoset polyurethane composition, wherein the one or more polycaprolactone composition or polycaprolactone has an average molecular weight of about 240 g/mol to about 10,000 g/mol; (b) one or more (e.g., 1, 2, 3, 4, or more) polyisocyanate comprising two or more isocyanate groups (e.g., one or more diisocyanate) that is present in the range of about 5.0 wt % to about 95.0 wt % of the two-component thermoset polyurethane composition; (c) optionally one or more (e.g., 1, 2, 3, 4, or more) additional polyol (e.g., an additional polyol other than the polycaprolactone composition of the present disclosure or the polycaprolactone of the present disclosure) that is present in the range of about 0.0 wt % to about 90.0 wt % of the two-component thermoset polyurethane composition; and (d) optionally one or more (e.g., 1, 2, 3, 4, or more) chain extender, wherein the one or more chain extender comprises at least one of one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition.

Another aspect of the present disclosure provides a two-component thermoset polyurethane composition comprising, consisting essentially of, or consists of a reaction product of: (a) a polyol resin that is present in the range of about 5.0 wt % to about 95.0 wt % of the two-component thermoset polyurethane composition, wherein the polyol resin comprises, consists essentially of, or consists of, the one or more (e.g., 1, 2, 3, 4, or more) polycaprolactone or polycaprolactone composition and a resin (e.g., an acrylic resin (such as a polyisocyanate cross-linking acrylic resin) and/or an epoxy resin), wherein the one or more polycaprolactone composition or polycaprolactone has an average molecular weight of about 240 g/mol to about 10,000 g/mol, and a ratio of resin to one or more polycaprolactone or polycaprolactone composition is about 70:30 to about 95:5 (e.g., about 85:15 to about 95:5 or about 80:20 to about 90:10); (a) a polyol resin that is present in the range of about 5.0 wt % to about 95.0 wt % of the two-component thermoset polyurethane composition, wherein the polyol resin comprises, consists essentially of, or consists of, the one or more (e.g., 1, 2, 3, 4, or more) polycaprolactone or polycaprolactone composition and a resin (e.g., an acrylic resin (such as a polyisocyanate cross-linking acrylic resin) and/or an epoxy resin), wherein the one or more polycaprolactone composition or polycaprolactone has an average molecular weight of about 240 g/mol to about 10,000 g/mol, and a ratio of resin to one or more polycaprolactone or polycaprolactone composition is about 70:30 to about 95:5 (e.g., about 85:15 to about 95:5 or about 80:20 to about 90:10); (c) optionally one or more (e.g., 1, 2, 3, 4, or more) additional polyol (e.g., an additional polyol other than the polycaprolactone composition of the present disclosure or the polycaprolactone of the present disclosure) that is present in the range of about 0.0 wt % to about 90.0 wt % of the two-component thermoset polyurethane composition; and (d) optionally one or more (e.g., 1, 2, 3, 4, or more) chain extender, wherein the one or more chain extender comprises at least one of one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition.

An additional aspect of the present disclosure provides a method of making or producing the two-component thermoset polyurethane composition of the present disclosure, the method comprising, consisting essentially of, or consists of, reacting the one or more polycaprolactone or polycaprolactone composition or polyol resin of the present disclosure, the one or more polyisocyanate (e.g., one or more diisocyanate), optionally the one or more additional polyol, and optionally the one or more chain extender.

An aspect of the present disclosure provides a two-component thermoset polyurethane composition made by a process comprising or consisting essentially of, reacting: (a) the one or more polycaprolactone or polycaprolactone composition or polyol resin of the present disclosure; (b) optionally, one or more (e.g., 1, 2, 3, 4, 5, or more) additional polyol; (c) one or more (e.g., 1, 2, 3, 4, 5, or more) polyisocyanate comprising two or more isocyanate groups (e.g., one or more diisocyanate); (d) optionally, one or more (e.g., 1, 2, 3, 4, 5, or more) defoamer (e.g., at least one of silicone defoamer, polysiloxane defoamer, or a combination thereof); (e) optionally, one or more (e.g., 1, 2, 3, 4, 5, or more) surface additive (e.g., silicone-containing surface additive); (f) optionally, one or more (e.g., 1, 2, 3, 4, 5, or more) solvent (e.g., at least one of butyl acetate, xylene, methoxy propyl acetate, or a combination thereof); and (g) one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a two-component thermoset polyurethane material or composition.

A further aspect of the present disclosure provides a method of making or producing the two-component thermoset polyurethane composition of the present disclosure, the method comprising, consisting essentially of, or consists of, reacting: (a) the one or more polycaprolactone or polycaprolactone composition or polyol resin of the present disclosure; (b) optionally, one or more (e.g., 1, 2, 3, 4, 5, or more) additional polyol; (c) one or more (e.g., 1, 2, 3, 4, 5, or more) polyisocyanate comprising two or more isocyanate groups (e.g., one or more diisocyanate); (d) optionally, one or more (e.g., 1, 2, 3, 4, 5, or more) defoamer (e.g., at least one of silicone defoamer, polysiloxane defoamer, or a combination thereof); (e) optionally, one or more (e.g., 1, 2, 3, 4, 5, or more) surface additive (e.g., silicone-containing surface additive); (f) optionally, one or more (e.g., 1, 2, 3, 4, 5, or more) solvent (e.g., at least one of butyl acetate, xylene, methoxy propyl acetate, or a combination thereof); and (g) one or more (e.g., 1, 2, 3, 4, 5, or more) catalyst (e.g., at least one of a bismuth catalyst (e.g., organobismuth in a carboxylic acid, dibutyltin dilaurate, dibutyltin dioctanoate, or a combination thereof), thereby forming a two-component thermoset polyurethane material or composition.

In any aspect or embodiment described herein, a first composition comprises, consists essentially of, or consists of, the one or more polycaprolactone or polycaprolactone composition or the polyol resin, optionally the one or more additional polyol, optionally the one or more defoamer, optionally the one or more surface additive, optionally the one or more solvent, and the one or more catalyst; a second composition comprises, consists essentially of, or consists of, the one or more polyisocyanate and optionally the one or more solvent; and the method further comprises, consists essentially of, or consists of, combining or mixing the first composition and the second composition, thereby forming the two-component polyurethane material or composition.

Another aspect of the present disclosure provides a polyurethane dispersion in aqueous or organic media, a two-component polyurethane coating, or a two-component polyurethane sealant, comprising, consisting essentially of, or consisting of, the two-component thermoset polyurethane or two-component thermoset polyurethane composition of the present disclosure, or a two-component thermoset polyurethane or two-component thermoset polyurethane composition prepared according to the method of the present disclosure.

In any aspect or embodiment described herein, the one or more (e.g., 1, 2, 3, 4, 5, or more) polyisocyanate comprises two or more isocyanate groups (e.g., one or more diisocyanate).

In any aspect or embodiment described herein, the two-component thermoset polyurethane composition comprises, consists essentially of, or consists of, a reaction product of: (a) the one or more (e.g., 1, 2, 3, 4, or more) polycaprolactone composition or polycaprolactone of the present disclosure that is present in the range of about 5.0 wt % to about 95.0 wt % of the two-component thermoset polyurethane composition, wherein the one or more polycaprolactone composition or polycaprolactone has an average molecular weight of about 240 g/mol to about 10,000 g/mol; (b) one or more (e.g., 1, 2, 3, 4, or more) polyisocyanate (e.g., diisocyanate) that is present in the range of about 5.0 wt % to about 95.0 wt % of the two-component thermoset polyurethane composition; (c) optionally one or more (e.g., 1, 2, 3, 4, or more) additional polyol (e.g., an additional polyol other than the polycaprolactone composition of the present disclosure or the polycaprolactone of the present disclosure) that is present in the range of about 0.0 wt % to about 90.0 wt % of the two-component thermoset polyurethane composition; and (d) optionally one or more (e.g., 1, 2, 3, 4, or more) chain extender, wherein the one or more chain extender comprises at least one of one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition. For example, in any aspect or embodiment described herein, a first composition comprises, consists essentially of, or consists of, the one or more polycaprolactone or polycaprolactone composition, the optionally one or more additional polyol, and the optionally one or more chain extender; and a second composition comprises, consists essentially of, or consists of, the one or more polyisocyanate, wherein the first composition and second composition are combined or mixed to form the reaction product.

In any aspect or embodiment described herein, the two-component thermoset polyurethane composition comprises, consists essentially of, or consists of, a reaction product of: (a) a polyol resin that is present in the range of about 5.0 wt % to about 95.0 wt % of the two-component thermoset polyurethane composition, wherein the polyol resin comprises, consists essentially of, or consists of, the one or more (e.g., 1, 2, 3, 4, or more) polycaprolactone or polycaprolactone composition and a resin (e.g., an acrylic resin (such as a polyisocyanate cross-linking acrylic resin) and/or an epoxy resin), wherein the one or more polycaprolactone composition or polycaprolactone has an average molecular weight of about 240 g/mol to about 10,000 g/mol, and a ratio of resin to one or more polycaprolactone or polycaprolactone composition is about 70:30 to about 95:5 (e.g., about 85:15 to about 95:5 or about 80:20 to about 90:10); (b) one or more (e.g., 1, 2, 3, 4, or more) polyisocyanate comprising two or more isocyanate groups (e.g., one or more diisocyanate) that is present in the range of about 5.0 wt % to about 95.0 wt % of the two-component thermoset polyurethane composition; (c) optionally one or more (e.g., 1, 2, 3, 4, or more) additional polyol (e.g., an additional polyol other than the polycaprolactone composition of the present disclosure or the polycaprolactone of the present disclosure) that is present in the range of about 0.0 wt % to about 90.0 wt % of the two-component thermoset polyurethane composition; and (d) optionally one or more (e.g., 1, 2, 3, 4, or more) chain extender, wherein the one or more chain extender comprises at least one of one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition. For example, in any aspect or embodiment described herein, a first composition comprising, consisting essentially of, or consisting of, the polyol resin, the optionally one or more additional polyol, and the optionally one or more chain extender; and a second composition comprising, consisting essentially of, or consisting of, the one or more polyisocyanate, wherein the first composition and second composition are combined or mixed to form the reaction product.

In any aspect or embodiment described herein, at least one of (a) the one or more polycaprolactone composition (e.g., polycaprolactone polyol or triol composition) or polycaprolactone (e.g., polycaprolactone polyol or triol) or polyol resin is present in the range of about 20.0 wt % to about 80.0 wt % (e.g., about 40.0 wt % to about 60.0 wt %) of the two-component thermoset polyurethane composition; (b) the one or more polyisocyanate (e.g., diisocyanate) is present in the range of about 20.0 wt % to about 80.0 wt % (e.g., about 40.0 wt % to about 60.0 wt %) of the two-component thermoset polyurethane composition; (c) the one or more chain extender is present in the range of about 0.0 wt % to about 15.0 wt % of the two-component thermoset polyurethane composition; or (d) a combination thereof.

In any aspect or embodiment described herein, at least one of (a) the one or more polycaprolactone composition (e.g., polycaprolactone polyol or triol composition) or polycaprolactone (e.g., polycaprolactone polyol or triol) or the polyol resin is present in the range of about 5.0 wt % to about 80.0 wt % (e.g., about 40.0 wt % to about 60.0 wt %) of the two-component thermoset polyurethane composition; (b) the one or more additional polyol is present in the range of up to about 75.0 wt % (e.g., up to about 55.0 wt %, about 15.0 wt % to about 75.0 wt %, or about 35.0 wt % to about 55.0 wt %) of the two-component thermoset polyurethane composition; (c) the combination of the one or more polycaprolactone composition and the one or more additional polyol is present in the range of about 20.0 wt % to about 80.0 wt % (e.g., about 40.0 wt % to about 60.0 wt %) of the two-component thermoset polyurethane composition; (d) the one or more polyisocyanate (e.g., diisocyanate) is present in the range of about 20.0 wt % to about 80.0 wt % (e.g., about 40.0 wt % to about 60.0 wt %) of the two-component thermoset polyurethane composition; (e) the one or more diol chain extender, the one or more diamine chain extender, or the combination thereof, is present in the range of about 0.0 wt % to about 15.0 wt % of the two-component thermoset polyurethane composition; or (f) a combination thereof.

In any aspect or embodiment described herein, the one or more polycaprolactone composition (e.g., polycaprolactone polyol or triol composition) of the present disclosure or polycaprolactone (e.g., polycaprolactone polyol or triol) or polyol resin of the present disclosure is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the two-component thermoset polyurethane composition.

In any aspect or embodiment described herein, the one or more polyisocyanate (e.g., one or more diisocyanate) is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the two-component thermoset polyurethane composition.

In any aspect or embodiment described herein, the one or more chain extender has a molecular weight of about 60.0 g/mol to about 500.0 g/mol, about 60.0 g/mol to about 400.0 g/mol, about 60.0 g/mol to about 300.0 g/mol, about 60.0 g/mol to about 200.0 g/mol, about 60.0 g/mol to about 160.0 g/mol, about 100.0 g/mol to about 500.0 g/mol, about 100.0 g/mol to about 400.0 g/mol, about 100.0 g/mol to about 300.0 g/mol, about 100.0 g/mol to about 200.0 g/mol, about 200.0 g/mol to about 500.0 g/mol, about 200.0 g/mol to about 400.0 g/mol, about 200.0 g/mol to about 300.0 g/mol, about 300.0 g/mol to about 500.0 g/mol, about 300.0 g/mol to about 400.0 g/mol, or about 400.0 g/mol to about 500.0 g/mol.

In any aspect or embodiment described herein, the one or more chain extender has an NCO:OH molar ratio of about 0.9:1 to about 2:1, about 0.9:1 to about 1.8:1, about 0.9:1 to about 1.6:1, about 0.9:1 to about 1.4:1, about 0.9:1 to about 1.2:1, about 0.9:1 to about 1:1, about 1:1 to about 2:1, about 1:1 to about 1.8:1, about 1:1 to about 1.6:1, about 1:1 to about 1.4:1, about 1:1 to about 1.2:1, about 1.2:1 to about 2:1, about 1.2:1 to about 1.8:1, about 1.2:1 to about 1.6:1, about 1.2:1 to about 1.4:1, about 1.4:1 to about 2:1, about 1.4:1 to about 1.8:1, about 1.4:1 to about 1.6:1, about 1.6:1 to about 2:1, about 1.6:1 to about 1.8:1, or about 1.8:1 to about 2:1.

In any aspect or embodiment described herein, the one or more chain extender is present in a range of about 0.0 wt % to about 25.0 wt %, about 0.0 wt % to about 20.0 wt %, about 0.0 wt % to about 15.0 wt %, about 0.0 wt % to about 10.0 wt %, about 0.0 wt % to about 5.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 25.0 wt %, about 10.0 wt % to about 20.0 wt %, about 10.0 wt % to about 15.0 wt %, about 15.0 wt % to about 25.0 wt %, about 15.0 wt % to about 20.0 wt %, or about 20.0 wt % to about 25.0 wt % of the total molecular weight of the two-component thermoset polyurethane composition.

In any aspect or embodiment described herein, the one or more polyisocyanate (e.g., one or more diisocyanate) comprises, consists essentially of, or is 4,4′-diphenylmethane diisocyanate, isophorone diisocyanate, bimethylene diisocyanate, trimethylene diisocyanate (e.g., 1,3-trimethylene diisocyanate, 2,3-trimethylene diisocyanate, 1,2-trimethylene diisocyanate, 2,2-trimethylene diisocyanate, or a mixture thereof), tetramethylene diisocyanate (e.g., 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, or a mixture thereof), pentamethylene diisocyanate (e.g., 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, or a mixture thereof), hexamethylene diisocyanate (e.g., 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, or a mixture thereof), heptamethylene diisocyanate (e.g., 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, or a mixture thereof), toluene diisocyanate (e.g., toluene-2,4-diisocyanate, toluene-2,6-diisocyanate, or a mixture thereof), naphthylene diisocyanate (e.g., 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, or a mixture thereof), cyclohexylmethane diisocyanate (e.g., 1,4-cyclohexylmethane diisocyanate, 2,4-cyclohexylmethane diisocyanate, 3,4-cyclohexylmethane diisocyanate, 4,4-cyclohexylmethane diisocyanate, or a mixture thereof), dicyclohexylmethane diisocyanate (e.g., 4,4′-dicyclohexylmethane diisocyanate, 1,4-dicyclohexylmethane diisocyanate, or a mixture thereof), or a mixture thereof.

In any aspect or embodiment described herein, the one or more polyisocyanate (e.g., one or more diisocyanate) comprises, consists essentially of, or is 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the one or more diol chain extender comprises, consists essentially of, comprises or is an aliphatic diol or an aromatic diol.

In any aspect or embodiment described herein, the one or more diol chain extender comprises, consists essentially of, or is an alkylene oxide or glycol, ethylene glycol, propanediol (e.g., 1,3-propanediol, 1,2-propanediol, 1,1-propanediol, 2,2-propanediol, or a mixture thereof), butanediol (e.g., 1,4-butanediol, 1,3-butanediol, 1,2-butanediol, 2,3-butanediol, 1,1-butanediol, 2,2-butanediol, or a mixture thereof), pentadiol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptadiol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, or a mixture thereof), dihydroxybenzene (e.g., 1,2-dihydroxybenzene, 1,3-dihydroxybenzene, 1,4-dihydroxybenzene, or a mixture thereof), di(hydroxyethyl)-hydroxyquinone (e.g., 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, or mixtures thereof), di(hydroxymethyl)-hydroxyquinone (e.g., 2,5-di-(hydroxyethyl)-hydroxyquinone, 2,3-di-(hydroxymethyl)-hydroxyquinone, 3,5-di-(hydroxymethyl)-hydroxyquinone, or mixtures thereof), di-(hydroxyethyl)-bisphenol A (e.g., 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A), or a mixture thereof), or a mixture thereof.

In any aspect or embodiment described herein, the one or more diol chain extender comprises, consists essentially of, or is ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof.

In any aspect or embodiment described herein, the one or more diamine chain extender comprises, consists essentially of, or is diaminodiphenylmethane (e.g., 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, or a mixture thereof), dichloro-diaminodiphenylmethane (e.g., 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane,4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, or a mixture thereof), diaminobenzene (e.g., 1,4-diaminobenzene, 1,2-diaminobenzene, 1,3-diaminobenzene, or a mixture thereof), dimethoxy-diamino biphenyl (e.g., 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl,4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, or a mixture thereof), dimethyl-diamino biphenyl (e.g., 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl,4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, or a mixture thereof), diamino biphenyl (e.g., 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, or a mixture thereof), dichloro-diamino biphenyl (e.g., 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl,4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof), or a mixture thereof.

In any aspect or embodiment described herein, the one or more diamine chain extender comprises, consists essentially of, or is 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof.

In any aspect or embodiment described herein, the two-component thermoset polyurethane composition is a polyurethane dispersion in aqueous or organic media, a two-component polyurethane coating, or a two-component polyurethane sealant.

In any aspect or embodiment described herein, the two-component thermoset polyurethane composition is prepared by a process comprising, consisting essentially of, or consists of, reacting the one or more polycaprolactone composition (e.g., polycaprolactone polyol composition) or polycaprolactone (e.g., polycaprolactone polyol) or polyol resin, the one or more polyisocyanate (e.g., one or more diisocyanate), and optionally, the one or more chain extender.

In any aspect or embodiment described herein, reacting the one or more polycaprolactone composition (e.g., polycaprolactone polyol composition) or polycaprolactone (e.g., polycaprolactone polyol) or polyol resin, the one or more polyisocyanate (e.g., one or more diisocyanate), optionally one or more additional polyol (e.g., an additional polyol other than the polycaprolactone composition of the present disclosure or the polycaprolactone of the present disclosure), and optionally the one or more chain extender is performed in the presence of a catalyst.

In any aspect or embodiment described herein, the catalyst comprises, consists essentially of, or consists of, one or more (e.g., 1, 2, 3, 4, 5, or more) urethane catalyst (e.g., at least one of one or more (e.g., 1, 2, 3, 4, 5, or more) tertiary amine catalyst, one or more (e.g., 1, 2, 3, 4, 5, or more) amine with isocyanate reactive group(s), one or more (e.g., 1, 2, 3, 4, 5, or more) organometallic catalyst, one or more (e.g., 1, 2, 3, 4, 5, or more) organobismuth catalyst (e.g., organobismuth in a carboxylic acid), one or more (e.g., 1, 2, 3, 4, 5, or more) tin catalyst, one or more (e.g., 1, 2, 3, 4,5 or more) catalyst for the trimerization of polyisocyanates, or a combination thereof.

In any aspect or embodiment described herein, the catalyst comprises, consists essentially of, or consists of, the catalyst comprises, consists essentially of, or consists of, at least one of (i) one or more (e.g., 1, 2, 3, 4, 5, or more) tertiary amine catalyst (e.g., a tertiary amine catalyst that is present in an amount of about 0.02 wt % to about 5.0 wt % of the reaction mixture) comprising, consists essentially of, or consists of, triethylenediamine, N-methylmorpholine, N, N-dimethylcyclohexylamine, pentamethyldiethylenetriamine, tetramethylethylenediamine, bis(dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof; (ii) one or more (e.g., 1, 2, 3, 4, 5, or more) organometallic catalyst (e.g., a organometallic catalyst that is present in an amount of about 0.001 to 1 wt % of the reaction mixture) comprising, consists essentially of, or consists of, at least one of organobismuth, organo mercury, organolead, organoferric, organotin catalysts, or a combination thereof (preferably organotin catalysts); (iii) one or more (e.g., 1, 2, 3, 4, 5, or more) tin catalysts comprising, consists essentially of, or consists of, at least one of stannous chloride, tin salts of carboxylic acids (e.g., dibutyltin dilaurate), stannous octoate, or a combination thereof; (iv) one or more (e.g., 1, 2, 3, 4, 5, or more) catalyst for the trimerization of polyisocyanates comprising, consists essentially of, or consists of, an alkali metal alkoxide; or (v) a combination thereof.

In any aspect or embodiment described herein, the one or more additional polyol is a polyol other than the polycaprolactone composition (e.g. polycaprolactone polyol or triol composition) of the present disclosure or the polycaprolactone (e.g., polycaprolactone polyol or triol) of the present disclosure.

In any aspect or embodiment described herein, the two-component thermoset polyurethane composition is prepared by a process comprising, consisting essentially of, or consists of, reacting the one or more polycaprolactone composition (e.g., polycaprolactone polyol or triol composition) or polycaprolactone (e.g., polycaprolactone polyol or triol) or polyol resin of the present disclosure, the one or more polyisocyanate (e.g., one or more diisocyanate), optionally one or more additional polyol, and optionally, the one or more chain extender. In any aspect or embodiment described herein, the one or more additional polyol comprises, consists essentially of, or consists of, at least one of one or more (e.g., 1, 2, 3, 4, 5, or more) dihydric alcohol (e.g., low-molecular-weight diol); one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol): one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g. low-molecular-weigh t octahydric alcohol); one or more (e.g., 1, 2, 3, 4, 5, or more) polyalkylene oxide having three or more hydroxyl groups (e.g., low-molecular weight polyalkylene oxide having three or more hydroxyl groups), or a combination thereof); or a combination thereof.

In any aspect or embodiment described herein, the two-component thermoset polyurethane composition is prepared by a process comprising or consisting essentially of, reacting: (a) the one or more polycaprolactone or polycaprolactone composition or polyol resin of the present disclosure; (b) optionally, one or more (e.g., 1, 2, 3, 4, 5, or more) additional polyol; (c) one or more (e.g., 1, 2, 3, 4, 5, or more) polyisocyanate comprising two or more isocyanate groups (e.g., one or more diisocyanate); (d) optionally, one or more (e.g., 1, 2, 3, 4, 5, or more) defoamer (e.g., at least one of silicone defoamer, polysiloxane defoamer, or a combination thereof); (e) optionally, one or more (e.g., 1, 2, 3, 4, 5, or more) surface additive (e.g., silicone-containing surface additive); (f) optionally, one or more (e.g., 1, 2, 3, 4, 5, or more) solvent (e.g., at least one of butyl acetate, xylene, methoxy propyl acetate, or a combination thereof); and (g) one or more (e.g., 1, 2, 3, 4, 5, or more) catalyst (e.g., a bismuth catalyst (e.g., at least one of organobismuth in a carboxylic acid), dibutyltin dilaurate, dibutyltin dioctanoate, or a combination thereof), thereby forming a two-component thermoset polyurethane material or composition.

In any aspect or embodiment described herein, a first composition comprising, consisting essentially of, or consisting of, the one or more polycaprolactone or polycaprolactone composition or the polyol resin, optionally the one or more additional polyol, optionally the one or more defoamer, optionally the one or more surface additive, optionally the one or more chain extender, optionally the one or more solvent, and the one or more catalyst; a second composition comprising, consisting essentially of, or consisting of, the one or more polyisocyanate and optionally the one or more solvent; and the process further comprises, consists essentially of, or consists of, combining or mixing the first composition and the second composition, thereby forming the two-component thermoset polyurethane material or composition.

In any aspect or embodiment described herein, the method or process further comprises or consists essentially of, adding to, and/or combining or mixing with, the the one or more polycaprolactone or polycaprolactone composition or the polyol resin, the optionally one or more additional polyol, optionally the one or more defoamer, optionally the one or more surface additive, optionally the one or more chain extender, optionally the one or more solvent, and the one or more catalyst: (a) optionally, one or more (e.g., 1, 2, 3, 4, 5, or more) cosolvent (e.g., at least one of butyl aetate, xylene, or a combination thereof); and (b) one or more (e.g., 1, 2, 3, 4, 5, or more) aliphatic polyisocyanate (e.g., at least one of hexamethylene diisocyanate (HDI) trimer, isophorone diisocyanate (IPDI) trimer, or a combination thereof), thereby forming a two-component thermoset polyurethane (e.g., polyurethane) material or composition.

In any aspect or embodiment described herein, at least one of: optionally the one or more cosolvent is present in the first composition, optionally the one or more cosolvent is present in the second composition, the one or more aliphatic polyisocyanate is present in the second composition, the one or more polyisocyanate is the one or more aliphatic polyisocyanate, or a combination thereof.

Another aspect of the present disclosure provides a method making or producing the two-component thermoset polyurethane composition of the present disclosure, the method comprising, consisting essentially of, or consists of, reacting:

In any aspect or embodiment described herein, the two-component thermoset polyurethane or two-component thermoset polyurethane composition (e.g., polyurethane composition or the first composition (e.g., Part A) of a two-component waterborne polyurethane coating) has a viscosity of about 0.1 mPa·s to about 1.2 mPa·s (e.g., about 0.1 mPa·s to about 1.2 mPa·s, about 0.1 mPa·s to about 1.1 mPa·s, about 0.1 mPa·s to about 1.0 mPa·s, about 0.1 mPa·s to about 0.9 mPa·s, about 0.1 mPa·s to about 0.8 mPa·s, about 0.1 mPa·s to about 0.7 mPa·s, v, about 0.1 mPa·s to about 0.6 mPa·s, about 0.1 mPa·s to about 0.5 mPa·s, about 0.1 mPa·s to about 0.4 mPa·s, about 0.1 mPa·s to about 0.3 mPa·s, about 0.2 mPa·s to about 1.2 mPa·s, about 0.2 mPa·s to about 1.1 mPa·s, about 0.2 mPa·s to about 1.0 mPa·s, about 0.2 mPa·s to about 0.9 mPa·s, about 0.2 mPa·s to about 0.8 mPa·s, about 0.2 mPa·s to about 0.7 mPa·s, v, about 0.2 mPa·s to about 0.6 mPa·s, about 0.2 mPa·s to about 0.5 mPa·s, about 0.2 mPa·s to about 0.4 mPa·s, about 0.3 mPa·s to about 1.2 mPa·s, about 0.3 mPa·s to about 1.1 mPa·s, about 0.3 mPa·s to about 1.0 mPa·s, about 0.3 mPa·s to about 0.9 mPa·s, about 0.3 mPa·s to about 0.8 mPa·s, about 0.3 mPa·s to about 0.7 mPa·s, about 0.3 mPa·s to about 0.6 mPa·s, about 0.3 mPa·s to about 0.5 mPa·s, about 0.4 mPa·s to about 1.2 mPa·s, about 0.4 mPa·s to about 1.1 mPa·s, about 0.4 mPa·s to about 1.0 mPa·s, about 0.4 mPa·s to about 0.9 mPa·s, about 0.4 mPa·s to about 0.8 mPa·s, about 0.4 mPa·s to about 0.7 mPa·s, v, about 0.4 mPa·s to about 0.6 mPa·s, about 0.5 mPa·s to about 1.2 mPa·s, about 0.5 mPa·s to about 1.1 mPa·s, about 0.5 mPa·s to about 1.0 mPa·s, about 0.5 mPa·s to about 0.9 mPa·s, about 0.5 mPa·s to about 0.8 mPa·s, about 0.5 mPa·s to about 0.7 mPa·s, about 0.6 mPa·s to about 1.2 mPa·s, about 0.6 mPa·s to about 1.1 mPa·s, about 0.6 mPa·s to about 1.0 mPa·s, about 0.6 mPa·s to about 0.9 mPa·s, about 0.6 mPa·s to about 0.8 mPa·s, about 0.7 mPa·s to about 1.2 mPa·s, about 0.7 mPa·s to about 1.1 mPa·s, about 0.7 mPa·s to about 1.0 mPa·s, about 0.7 mPa·s to about 0.9 mPa·s, about 0.8 mPa·s to about 1.2 mPa·s, about 0.8 mPa·s to about 1.1 mPa·s, about 0.8 mPa·s to about 1.0 mPa·s, about 0.9 mPa·s to about 1.2 mPa·s, about 0.9 mPa·s to about 1.1 mPa·s, or about 1.0 mPa·s to about 1.2 mPa·s) at a temperature of about 25° C. to about 55° C. (e.g., about 25° C. to about 55° C., about 25° C. to about 50° C., about 25° C. to about 45° C., about 25° C. to about 40° C., about 25° C. to about 35° C., about 25° C. to about 30° C., about 30° C. to about 55° C., about 30° C. to about 50° C., about 30° C. to about 45° C., about 30° C. to about 40° C., about 30° C. to about 35° C., about 35° C. to about 55° C., about 35° C. to about 50° C., about 35° C. to about 45° C., about 35° C. to about 40° C., about 40° C. to about 55° C., about 40° C. to about 50° C., about 40° C. to about 45° C., about 45° C. to about 55° C., about 45° C. to about 50° C., or about 50° C. to about 55° C.).

### Polycaprolactone or Polycaprolactone Composition or Polyol Resin

In any aspect or embodiment described herein, the polycaprolactone (e.g., polycaprolactone polyol or triol) comprises, consists essentially of, or consists of, (i) one or more (e.g., 1, 2, 3, 4, or more) unsubstituted or substitute caprolactone monomers (e.g., ε-caprolactone), and (ii) an initiator comprising, or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

In any aspect or embodiment described herein, the polycaprolactone (e.g., polycaprolactone polyol or triol) comprising, consisting essentially of, or consists of, (i) three caprolactone polymers attached to (ii) an initiator comprising, or consisting essentially of, at least (e.g., 1 or 2) one primary hydroxyl group (e.g., two primary hydroxyl groups) and at least one (e.g., 1 or 2) secondary hydroxyl group (e.g., one secondary hydroxyl group), wherein each of the three caprolactone polymers is independently comprising, consisting essentially of, or consisting of, one or more (e.g., 1, 2, 3, 4, or more) unsubstituted or substitute caprolactone monomers (e.g., ε-caprolactone).

In any aspect or embodiment described herein, the polycaprolactone composition (e.g., polycaprolactone polyol or triol composition) comprises a polycaprolactone of the present disclosure (e.g., a polycaprolactone polyol or triol of the present disclosure). For example, in any aspect or embodiment described herein, the polycaprolactone composition (e.g., polycaprolactone polyol or triol composition) comprises, consists essentially of, or consists of, a polycaprolactone composition comprising, consisting essentially of, or consisting of, (i) one or more (e.g., 1, 2, 3, 4, or more) unsubstituted or substitute caprolactone monomers (e.g., ε-caprolactone), and (ii) an initiator comprising, or consisting essentially of, at least one (e.g., 1 or 2) primary hydroxyl group (e.g., two primary hydroxyl groups) and at least one (e.g., 1 or 2) secondary hydroxyl group (e.g., one secondary hydroxyl group), wherein the polycaprolactone (e.g., polycaprolactone polyol or triol) has an average molecular weight of about 240 g/mol to about 10,000 g/mol (e.g., about 300 g/mol to about 5,000 g/mol, about 300 g/mol to about 3,000 g/mol, or about 300 g/mol to about 1,000 g/mol).

In any aspect or embodiment described herein, a method of making or producing the polycaprolactone composition (e.g., polycaprolactone polyol composition) or polycaprolactone (e.g., polycaprolactone polyol) of the present disclosure, the method comprising, consisting essentially of, or consisting of, reacting the initiator and the one or more caprolactone monomer.

In any aspect or embodiment described herein, the three caprolactone polymers are attached to the initiator via an oxygen of the initiator.

In any aspect or embodiment described herein, the polycaprolactone has the chemical structure:

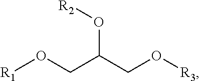

wherein each of R1, R2, and R3 are independently a caprolactone polymers is independently comprising, consisting essentially of, or consisting of, one or more (e.g., 1, 2, 3, 4, or more) unsubstituted or substitute caprolactone monomers (e.g., ε-caprolactone).

In any aspect or embodiment described herein, at least one of (a) the initiator comprises two primary hydroxyl groups, (b) the initiator comprises one secondary hydroxyl group, or (3) a combination thereof. In any aspect or embodiment described herein, the initiator is a trifunctional initiator. In any aspect or embodiment described herein, the initiator is at least one of glycerol, glucose, sucrose, fructose, or a combination thereof (e.g., glycerol).

In any aspect or embodiment described herein, the polycaprolactone reaction product is produced by a process comprising, consisting essentially of, or consisting of, at least one of: (a) reacting the initiator and the one or more caprolactone monomer; (b) reacting the initiator and the one or more caprolactone monomer at a temperature of about 120° C. to about 200° C.; (c) reacting the initiator and the one or more caprolactone monomer for about 0.25 hours to about 100.0 hours; (d) reacting the initiator and the one or more caprolactone monomer in a standard atmosphere or an inert atmosphere (e.g., at least one of a nitrogen atmosphere, an argon atmosphere, or a combination thereof); (e) reacting the initiator and the one or more caprolactone monomer at a pressure of less than about 1,000 millibar (mbar); (f) reacting the initiator and the one or more caprolactone monomer in the presence of a catalyst (e.g., a catalyst for ring-opening polymerization); or (g) a combination thereof. In any aspect or embodiment described herein, the polycaprolactone reaction product is produced by a process comprising, consisting essentially of, or consisting of, at least one of: (a) reacting the initiator and the one or more caprolactone monomer; (b) reacting the initiator and the one or more caprolactone monomer at a temperature of about 120° C. to about 200° C.; (c) reacting the initiator and the one or more caprolactone monomer for about 0.25 hours to about 100.0 hours; (d) reacting the initiator and the one or more caprolactone monomer in a standard atmosphere or an inert atmosphere (e.g., at least one of a nitrogen atmosphere, an argon atmosphere, or a combination thereof); (e) reacting the initiator and the one or more caprolactone monomer at a pressure of less than about 1,000 millibar (mbar); (f) reacting the initiator and the one or more caprolactone monomer in the presence of a catalyst (e.g., a catalyst for ring-opening polymerization), wherein the catalyst comprises, consists essentially of, or consists of, at least one of (1) a zinc-based catalyst (such as, at least one of zinc lactate, zinc oxide, zinc powder, diethyl zinc, or a combination thereof), (2) a tin-based catalyst (such as, at least one of stannous octoate, dibutyltin dilaurate (DBTL), tin lactate, tin oxide, tin dioxide, stannous oxide, stannous lactate, stannous chloride, tin powder, or a combination thereof), (3) a titanium-based catalyst (such as, at least one of tetra-n-butyl titanate (TnBT), tetra-isopropyl titanate (TPT), or a combination thereof), (4) a zirconium-based catalyst, or (5) a combination thereof; or (g) a combination thereof. In any aspect or embodiment described herein, the catalyst is a catalyst for ring-opening polymerization. For example, in any aspect or embodiment described herein, the catalyst or the catalyst for ring-opening polymerization includes, consists essentially of, or consists of, at least one of (1) a zinc-based catalyst (such as, at least one of zinc lactate, zinc oxide, zinc powder, diethyl zinc, or a combination thereof), (2) a tin-based catalyst (such as, at least one of stannous octoate, dibutyltin dilaurate (DBTL), tin lactate, tin oxide, tin dioxide, stannous oxide, stannous lactate, stannous chloride, tin powder, or a combination thereof), (3) a zirconium-based catalyst, (4) a titanium-based catalyst (such as, at least one of tetra-n-butyl titanate (TnBT), tetra-isopropyl titanate (TPT), or a combination thereof), or (5) a combination thereof.

In any aspect or embodiment described herein, the one or more caprolactone monomer comprises, consists essentially of, or consists of an unsubstituted caprolactone (e.g., unsubstituted ε-caprolactone).

In any aspect or embodiment described herein, the one or more caprolactone monomer comprises, consists essentially of, or consists of a substituted caprolactone (e.g., substituted ε-caprolactone).

In any aspect or embodiment described herein, the initiator is present in the range of about 1.0 wt % to about 95.0 wt %, about 1.0 wt % to about 90.0 wt %, about 1.0 wt % to about 85.0 wt %, about 1.0 wt % to about 80.0 wt %, about 1.0 wt % to about 75.0 wt %, about 1.0 wt % to about 70.0 wt %, about 1.0 wt % to about 65.0 wt %, about 1.0 wt % to about 60.0 wt %, about 1.0 wt % to about 55.0 wt %, about 1.0 wt % to about 50.0 wt %, about 1.0 wt % to about 45.0 wt %, about 1.0 wt % to about 40.0 wt %, about 1.0 wt % to about 35.0 wt %, about 1.0 wt % to about 30.0 wt %, about 1.0 wt % to about 25.0 wt %, about 1.0 wt % to about 20.0 wt %, about 1.0 wt % to about 15.0 wt %, about 1.0 wt % to about 10.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone composition, polycaprolactone, or reaction mixture to produce the same.

In any aspect or embodiment described herein, the one or more caprolactone monomer is present in the range of about 5.0 wt % to about 99.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 5.0 wt % to about 99.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 99.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 99.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 99.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 99.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 99.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 99.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 99.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 99.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 99.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 99.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 99.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 99.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 99.0 wt %, about 75.0 wt % to about 95.0 wt %, about 75.0 wt % to about 90.0 wt %, about 75.0 wt % to about 85.0 wt %, about 85.0 wt % to about 99.0 wt %, about 80.0 wt % to about 95.0 wt %, about 80.0 wt % to about 90.0 wt %, about 85.0 wt % to about 99.0 wt %, about 85.0 wt % to about 95.0 wt %, or about 90.0 wt % to about 99.0 wt %, of the total molecular weight of the polycaprolactone composition, polycaprolactone, or reaction mixture to produce the same.

For example, in any aspect or embodiment described herein, at least one of (a) the initiator is present in the range of about 10.0 wt % to about 40.0 wt % (e.g., about 15.0 wt % to about 35.0 wt %) of the total molecular weight of the polycaprolactone composition, polycaprolactone, or reaction mixture to produce the same, (b) the one or more caprolactone monomer is present in the range of about 60.0 wt % to about 90.0 wt % (e.g., about 65.0 wt % to about 85.0 wt %) of the total molecular weight of the polycaprolactone composition, polycaprolactone, or reaction mixture to produce the same, or (c) a combination thereof.

In any aspect or embodiment described herein, the polycaprolactone (e.g., polycaprolactone polyol or triol) has an average molecular weight of about 240 g/mol to about 10,000 g/mol, about 240 g/mol to about 9,000 g/mol, about 240 g/mol to about 8,000 g/mol, about 240 g/mol to about 7,000 g/mol, about 240 g/mol to about 6,000 g/mol, about 240 g/mol to about 5,000 g/mol, about 240 g/mol to about 4,000 g/mol, about 240 g/mol to about 3,000 g/mol, about 240 g/mol to about 2,000 g/mol, about 240 g/mol to about 750 g/mol, about 240 g/mol to about 600 g/mol, about 240 g/mol to about 500 g/mol, about 300 g/mol to about 10,000 g/mol, about 300 g/mol to about 9,000 g/mol, about 300 g/mol to about 8,000 g/mol, about 300 g/mol to about 7,000 g/mol, about 300 g/mol to about 6,000 g/mol, about 300 g/mol to about 5,000 g/mol, about 300 g/mol to about 4,000 g/mol, about 300 g/mol to about 3,000 g/mol, about 300 g/mol to about 2,000 g/mol, about 300 g/mol to about 750 g/mol, about 300 g/mol to about 600 g/mol, about 300 g/mol to about 500 g/mol, about 400 g/mol to about 10,000 g/mol, about 400 g/mol to about 9,000 g/mol, about 400 g/mol to about 8,000 g/mol, about 400 g/mol to about 7,000 g/mol, about 400 g/mol to about 6,000 g/mol, about 400 g/mol to about 5,000 g/mol, about 400 g/mol to about 4,000 g/mol, about 400 g/mol to about 3,000 g/mol, about 400 g/mol to about 2,000 g/mol, about 400 g/mol to about 750 g/mol, about 1,000 g/mol to about 10,000 g/mol, about 1,000 g/mol to about 9,000 g/mol, about 1,000 g/mol to about 8,000 g/mol, about 1,000 g/mol to about 7,000 g/mol, about 1,000 g/mol to about 6,000 g/mol, about 1,000 g/mol to about 5,000 g/mol, about 1,000 g/mol to about 4,000 g/mol, about 1,000 g/mol to about 3,000 g/mol, about 1,000 g/mol to about 2,000 g/mol, about 1,500 g/mol to about 10,000 g/mol, about 1,500 g/mol to about 9,000 g/mol, about 1,500 g/mol to about 8,000 g/mol, about 1,500 g/mol to about 7,000 g/mol, about 1,500 g/mol to about 6,000 g/mol, about 1,500 g/mol to about 5,000 g/mol, about 1,500 g/mol to about 4,000 g/mol, about 1,500 g/mol to about 3,000 g/mol, about 2,000 g/mol to about 10,000 g/mol, about 2,000 g/mol to about 9,000 g/mol, about 2,000 g/mol to about 8,000 g/mol, about 2,000 g/mol to about 7,000 g/mol, about 2,000 g/mol to about 6,000 g/mol, about 2,000 g/mol to about 5,000 g/mol, about 2,000 g/mol to about 4,000 g/mol, about 2,000 g/mol to about 3,000 g/mol, about 2,500 g/mol to about 10,000 g/mol, about 2,500 g/mol to about 9,000 g/mol, about 2,500 g/mol to about 8,000 g/mol, about 2,500 g/mol to about 7,000 g/mol, about 2,500 g/mol to about 6,000 g/mol, about 2,500 g/mol to about 5,000 g/mol, about 2,500 g/mol to about 4,000 g/mol, about 3,000 g/mol to about 10,000 g/mol, about 3,000 g/mol to about 9,000 g/mol, about 3,000 g/mol to about 8,000 g/mol, about 3,000 g/mol to about 7,000 g/mol, about 3,000 g/mol to about 6,000 g/mol, about 3,000 g/mol to about 5,000 g/mol, about 3,000 g/mol to about 4,000 g/mol, about 3,500 g/mol to about 10,000 g/mol, about 3,500 g/mol to about 9,000 g/mol, about 3,500 g/mol to about 8,000 g/mol, about 3,500 g/mol to about 7,000 g/mol, about 3,500 g/mol to about 6,000 g/mol, about 3,500 g/mol to about 5,000 g/mol, about 4,000 g/mol to about 10,000 g/mol, about 4,000 g/mol to about 9,000 g/mol, about 4,000 g/mol to about 8,000 g/mol, about 4,000 g/mol to about 7,000 g/mol, about 4,000 g/mol to about 6,000 g/mol, about 4,000 g/mol to about 5,000 g/mol, about 4,500 g/mol to about 10,000 g/mol, about 4,500 g/mol to about 9,000 g/mol, about 4,500 g/mol to about 8,000 g/mol, about 4,500 g/mol to about 7,000 g/mol, about 4,500 g/mol to about 6,000 g/mol, about 5,000 g/mol to about 10,000 g/mol, about 5,000 g/mol to about 9,000 g/mol, about 5,000 g/mol to about 8,000 g/mol, about 5,000 g/mol to about 7,000 g/mol, about 5,000 g/mol to about 6,000 g/mol, about 5,500 g/mol to about 10,000 g/mol, about 5,500 g/mol to about 9,000 g/mol, about 5,500 g/mol to about 8,000 g/mol, about 5,500 g/mol to about 7,000 g/mol, about 6,000 g/mol to about 10,000 g/mol, about 6,000 g/mol to about 9,000 g/mol, about 6,000 g/mol to about 8,000 g/mol, about 6,000 g/mol to about 7,000 g/mol, about 6,500 g/mol to about 10,000 g/mol, about 6,500 g/mol to about 9,000 g/mol, about 6,500 g/mol to about 8,000 g/mol, about 7,000 g/mol to about 10,000 g/mol, about 7,000 g/mol to about 9,000 g/mol, about 7,000 g/mol to about 8,000 g/mol, about 7,500 g/mol to about 10,000 g/mol, about 7,500 g/mol to about 9,000 g/mol, about 8,000 g/mol to about 10,000 g/mol, about 8,000 g/mol to about 9,000 g/mol, or about 8,500 g/mol to about 10,000 g/mol).

In any aspect or embodiment described herein, the polycaprolactone (e.g., polycaprolactone polyol or triol) has an average molecular weight of about 240 g/mol to about 5,000 g/mol (e.g., about 240 g/mol to about 3,000 g/mol, about 240 g/mol to about 1,000 g/mol, about 240 g/mol to about 750 g/mol, or about 240 g/mol to about 600 g/mol). For example, in any aspect or embodiment described herein, the polycaprolactone (e.g., polycaprolactone polyol or triol) has an average molecular weight of about 300 g/mol to about 5,000 g/mol (e.g., about 300 g/mol to about 3,000 g/mol, about 300 g/mol to about 1,000 g/mol, about 300 g/mol to about 750 g/mol, or about 300 g/mol to about 600 g/mol).

In any aspect or embodiment described herein, the polycaprolactone reaction product is produced by a process comprising, consisting essentially of, or consisting of, at least one of: (a) reacting the initiator and the one or more caprolactone monomer; (b) reacting the initiator and the one or more caprolactone monomer at a temperature of about 120° C. to about 200° C.; (c) reacting the initiator and the one or more caprolactone monomer for about 0.25 hours to about 100.0 hours; (d) reacting the initiator and the one or more caprolactone monomer in a standard atmosphere or an inert atmosphere (e.g., at least one of a nitrogen atmosphere, an argon atmosphere, or a combination thereof); (d) reacting the initiator and the one or more caprolactone monomer at a pressure of less than about 1,000 millibar (mbar); (e) reacting the initiator and the one or more caprolactone monomer in the presence of a catalyst (e.g., a catalyst for ring-opening polymerization); or (f) a combination thereof.

In any aspect or embodiment described herein, reacting the initiator and the one or more caprolactone monomer comprises, consists essentially of, or consists of, polymerizing (e.g., ring opening polymerization) the initiator and the one or more caprolactone monomer.

For example, in any aspect or embodiment described herein, reacting the initiator and the one or more caprolactone monomer is performed at a temperature of about 120° C. to about 200° C., about 120° C. to about 190° C., about 120° C. to about 180° C., about 120° C. to about 170° C., about 120° C. to about 160° C., about 120° C. to about 150° C., about 120° C. to about 140° C., about 120° C. to about 130° C., about 130° C. to about 200° C., about 130° C. to about 190° C., about 130° C. to about 180° C., about 130° C. to about 170° C., about 130° C. to about 160° C., about 130° C. to about 150° C., about 130° C. to about 140° C., about 140° C. to about 200° C., about 140° C. to about 190° C., about 140° C. to about 180° C., about 140° C. to about 170° C., about 140° C. to about 160° C., about 140° C. to about 150° C., about 150° C. to about 200° C., about 150° C. to about 190° C., about 150° C. to about 180° C., about 150° C. to about 170° C., about 150° C. to about 160° C., about 160° C. to about 200° C., about 160° C. to about 190° C., about 160° C. to about 180° C., about 160° C. to about 170° C., about 170° C. to about 200° C., about 170° C. to about 190° C., about 170° C. to about 180° C., about 180° C. to about 200° C., about 180° C. to about 190° C., or about 190° C. to about 200° C.

For example, in any aspect or embodiment described herein, reacting the initiator and the one or more caprolactone monomer for about 0.25 hours to about 100.0 hours, about 0.25 hours to about 95.0 hours, about 0.25 hours to about 90.0 hours, about 0.25 hours to about 85.0 hours, about 0.25 hours to about 80.0 hours, about 0.25 hours to about 75.0 hours, about 0.25 hours to about 70.0 hours, about 0.25 hours to about 65.0 hours, about 0.25 hours to about 60.0 hours, about 0.25 hours to about 55.0 hours, about 0.25 hours to about 50.0 hours, about 0.25 hours to about 45.0 hours, about 0.25 hours to about 40.0 hours, about 0.25 hours to about 35.0 hours, about 0.25 hours to about 30.0 hours, about 0.25 hours to about 25.0 hours, about 0.25 hours to about 20.0 hours, about 0.25 hours to about 15.0 hours, about 0.25 hours to about 10.0 hours, about 0.25 hours to about 9.0 hours, about 0.25 hours to about 8.0 hours, about 0.25 hours to about 7.0 hours, about 0.25 hours to about 6.0 hours, about 0.25 hours to about 5.0 hours, about 0.25 hours to about 4.0 hours, about 0.25 hours to about 3.0 hours, about 0.25 hours to about 2.0 hours, about 0.25 hours to about 1.0 hours, about 0.25 hours to about 0.75 hours, about 0.50 hours to about 100.0 hours, about 0.50 hours to about 95.0 hours, about 0.50 hours to about 90.0 hours, about 0.50 hours to about 85.0 hours, about 0.50 hours to about 80.0 hours, about 0.50 hours to about 75.0 hours, about 0.50 hours to about 70.0 hours, about 0.50 hours to about 65.0 hours, about 0.50 hours to about 60.0 hours, about 0.50 hours to about 55.0 hours, about 0.50 hours to about 50.0 hours, about 0.50 hours to about 45.0 hours, about 0.50 hours to about 40.0 hours, about 0.50 hours to about 35.0 hours, about 0.50 hours to about 30.0 hours, about 0.50 hours to about 25.0 hours, about 0.50 hours to about 20.0 hours, about 0.50 hours to about 15.0 hours, about 0.50 hours to about 10.0 hours, about 0.50 hours to about 9.0 hours, about 0.50 hours to about 8.0 hours, about 0.50 hours to about 7.0 hours, about 0.50 hours to about 6.0 hours, about 0.50 hours to about 5.0 hours, about 0.50 hours to about 4.0 hours, about 0.50 hours to about 3.0 hours, about 0.50 hours to about 2.0 hours, about 0.50 hours to about 1.0 hours, about 1.0 hours to about 100.0 hours, about 1.0 hours to about 95.0 hours, about 1.0 hours to about 90.0 hours, about 1.0 hours to about 85.0 hours, about 1.0 hours to about 80.0 hours, about 1.0 hours to about 75.0 hours, about 1.0 hours to about 70.0 hours, about 1.0 hours to about 65.0 hours, about 1.0 hours to about 60.0 hours, about 1.0 hours to about 55.0 hours, about 1.0 hours to about 50.0 hours, about 1.0 hours to about 45.0 hours, about 1.0 hours to about 40.0 hours, about 1.0 hours to about 35.0 hours, about 1.0 hours to about 30.0 hours, about 1.0 hours to about 25.0 hours, about 1.0 hours to about 20.0 hours, about 1.0 hours to about 15.0 hours, about 1.0 hours to about 10.0 hours, about 1.0 hours to about 9.0 hours, about 1.0 hours to about 8.0 hours, about 1.0 hours to about 7.0 hours, about 1.0 hours to about 6.0 hours, about 1.0 hours to about 5.0 hours, about 1.0 hours to about 4.0 hours, about 1.0 hours to about 3.0 hours, about 5.0 hours to about 100.0 hours, about 5.0 hours to about 95.0 hours, about 5.0 hours to about 90.0 hours, about 5.0 hours to about 85.0 hours, about 5.0 hours to about 80.0 hours, about 5.0 hours to about 75.0 hours, about 5.0 hours to about 70.0 hours, about 5.0 hours to about 65.0 hours, about 5.0 hours to about 60.0 hours, about 5.0 hours to about 55.0 hours, about 5.0 hours to about 50.0 hours, about 5.0 hours to about 45.0 hours, about 5.0 hours to about 40.0 hours, about 5.0 hours to about 35.0 hours, about 5.0 hours to about 30.0 hours, about 5.0 hours to about 25.0 hours, about 5.0 hours to about 20.0 hours, about 5.0 hours to about 15.0 hours, about 5.0 hours to about 10.0 hours, about 10.0 hours to about 100.0 hours, about 10.0 hours to about 95.0 hours, about 10.0 hours to about 90.0 hours, about 10.0 hours to about 85.0 hours, about 10.0 hours to about 80.0 hours, about 10.0 hours to about 75.0 hours, about 10.0 hours to about 70.0 hours, about 10.0 hours to about 65.0 hours, about 10.0 hours to about 60.0 hours, about 10.0 hours to about 55.0 hours, about 10.0 hours to about 50.0 hours, about 10.0 hours to about 45.0 hours, about 10.0 hours to about 40.0 hours, about 10.0 hours to about 35.0 hours, about 10.0 hours to about 30.0 hours, about 10.0 hours to about 25.0 hours, about 10.0 hours to about 20.0 hours, about 10.0 hours to about 15.0 hours, about 15.0 hours to about 100.0 hours, about 15.0 hours to about 95.0 hours, about 15.0 hours to about 90.0 hours, about 15.0 hours to about 85.0 hours, about 15.0 hours to about 80.0 hours, about 15.0 hours to about 75.0 hours, about 15.0 hours to about 70.0 hours, about 15.0 hours to about 65.0 hours, about 15.0 hours to about 60.0 hours, about 15.0 hours to about 55.0 hours, about 15.0 hours to about 50.0 hours, about 15.0 hours to about 45.0 hours, about 15.0 hours to about 40.0 hours, about 15.0 hours to about 35.0 hours, about 15.0 hours to about 30.0 hours, about 15.0 hours to about 25.0 hours, about 15.0 hours to about 20.0 hours, about 20.0 hours to about 100.0 hours, about 20.0 hours to about 95.0 hours, about 20.0 hours to about 90.0 hours, about 20.0 hours to about 85.0 hours, about 20.0 hours to about 80.0 hours, about 20.0 hours to about 75.0 hours, about 20.0 hours to about 70.0 hours, about 20.0 hours to about 65.0 hours, about 20.0 hours to about 60.0 hours, about 20.0 hours to about 55.0 hours, about 20.0 hours to about 50.0 hours, about 20.0 hours to about 45.0 hours, about 20.0 hours to about 40.0 hours, about 20.0 hours to about 35.0 hours, about 20.0 hours to about 30.0 hours, about 20.0 hours to about 25.0 hours, about 25.0 hours to about 100.0 hours, about 25.0 hours to about 95.0 hours, about 25.0 hours to about 90.0 hours, about 25.0 hours to about 85.0 hours, about 25.0 hours to about 80.0 hours, about 25.0 hours to about 75.0 hours, about 25.0 hours to about 70.0 hours, about 25.0 hours to about 65.0 hours, about 25.0 hours to about 60.0 hours, about 25.0 hours to about 55.0 hours, about 25.0 hours to about 50.0 hours, about 25.0 hours to about 45.0 hours, about 25.0 hours to about 40.0 hours, about 25.0 hours to about 35.0 hours, about 25.0 hours to about 30.0 hours, about 30.0 hours to about 100.0 hours, about 30.0 hours to about 95.0 hours, about 30.0 hours to about 90.0 hours, about 30.0 hours to about 85.0 hours, about 30.0 hours to about 80.0 hours, about 30.0 hours to about 75.0 hours, about 30.0 hours to about 70.0 hours, about 30.0 hours to about 65.0 hours, about 30.0 hours to about 60.0 hours, about 30.0 hours to about 55.0 hours, about 30.0 hours to about 50.0 hours, about 30.0 hours to about 45.0 hours, about 30.0 hours to about 40.0 hours, about 30.0 hours to about 35.0 hours, about 35.0 hours to about 100.0 hours, about 35.0 hours to about 95.0 hours, about 35.0 hours to about 90.0 hours, about 35.0 hours to about 85.0 hours, about 35.0 hours to about 80.0 hours, about 35.0 hours to about 75.0 hours, about 35.0 hours to about 70.0 hours, about 35.0 hours to about 65.0 hours, about 35.0 hours to about 60.0 hours, about 35.0 hours to about 55.0 hours, about 35.0 hours to about 50.0 hours, about 35.0 hours to about 45.0 hours, about 35.0 hours to about 40.0 hours, about 40.0 hours to about 100.0 hours, about 40.0 hours to about 95.0 hours, about 40.0 hours to about 90.0 hours, about 40.0 hours to about 85.0 hours, about 40.0 hours to about 80.0 hours, about 40.0 hours to about 75.0 hours, about 40.0 hours to about 70.0 hours, about 40.0 hours to about 65.0 hours, about 40.0 hours to about 60.0 hours, about 40.0 hours to about 55.0 hours, about 40.0 hours to about 50.0 hours, about 40.0 hours to about 45.0 hours, about 45.0 hours to about 100.0 hours, about 45.0 hours to about 95.0 hours, about 45.0 hours to about 90.0 hours, about 45.0 hours to about 85.0 hours, about 45.0 hours to about 80.0 hours, about 45.0 hours to about 75.0 hours, about 45.0 hours to about 70.0 hours, about 45.0 hours to about 65.0 hours, about 45.0 hours to about 60.0 hours, about 45.0 hours to about 55.0 hours, about 45.0 hours to about 50.0 hours, about 50.0 hours to about 100.0 hours, about 50.0 hours to about 95.0 hours, about 50.0 hours to about 90.0 hours, about 50.0 hours to about 85.0 hours, about 50.0 hours to about 80.0 hours, about 50.0 hours to about 75.0 hours, about 50.0 hours to about 70.0 hours, about 50.0 hours to about 65.0 hours, about 50.0 hours to about 60.0 hours, about 50.0 hours to about 55.0 hours, about 55.0 hours to about 100.0 hours, about 55.0 hours to about 95.0 hours, about 55.0 hours to about 90.0 hours, about 55.0 hours to about 85.0 hours, about 55.0 hours to about 80.0 hours, about 55.0 hours to about 75.0 hours, about 55.0 hours to about 70.0 hours, about 55.0 hours to about 65.0 hours, about 55.0 hours to about 60.0 hours, about 60.0 hours to about 100.0 hours, about 60.0 hours to about 95.0 hours, about 60.0 hours to about 90.0 hours, about 60.0 hours to about 85.0 hours, about 60.0 hours to about 80.0 hours, about 60.0 hours to about 75.0 hours, about 60.0 hours to about 70.0 hours, about 60.0 hours to about 65.0 hours, about 65.0 hours to about 100.0 hours, about 65.0 hours to about 95.0 hours, about 65.0 hours to about 90.0 hours, about 65.0 hours to about 85.0 hours, about 65.0 hours to about 80.0 hours, about 65.0 hours to about 75.0 hours, about 65.0 hours to about 70.0 hours, about 70.0 hours to about 100.0 hours, about 70.0 hours to about 95.0 hours, about 70.0 hours to about 90.0 hours, about 70.0 hours to about 85.0 hours, about 70.0 hours to about 80.0 hours, about 70.0 hours to about 75.0 hours, about 75.0 hours to about 100.0 hours, about 75.0 hours to about 95.0 hours, about 75.0 hours to about 90.0 hours, about 75.0 hours to about 85.0 hours, about 75.0 hours to about 80.0 hours, about 80.0 hours to about 100.0 hours, about 80.0 hours to about 95.0 hours, about 80.0 hours to about 90.0 hours, about 80.0 hours to about 85.0 hours, about 85.0 hours to about 100.0 hours, about 85.0 hours to about 95.0 hours, about 85.0 hours to about 90.0 hours, about 90.0 hours to about 100.0 hours, about 90.0 hours to about 95.0 hours, or about 95.0 hours to about 100.0 hours.

For example, in any aspect or embodiment described herein, reacting the initiator and the one or more caprolactone monomer is performed at a pressure of about 0.0 millibar to about 1,000 millibar, about 0.1 to about 1,000 millibar, or about 0.2 millibar to about 1,000 millibar) (e.g., about 0 millibar to about 1,000 millibar, about 0 millibar to about 900 millibar, about 0 millibar to about 800 millibar, about 0 millibar to about 700 millibar, about 0 millibar to about 600 millibar, about 0 millibar to about 500 millibar, about 0 millibar to about 400 millibar, about 0 millibar to about 300 millibar, about 0 millibar to about 200 millibar, about 0 millibar to about 100 millibar, about 0.1 millibar to about 1,000 millibar, about 0.1 millibar to about 900 millibar, about 0.1 millibar to about 800 millibar, about 0.1 millibar to about 700 millibar, about 0.1 millibar to about 600 millibar, about 0.1 millibar to about 500 millibar, about 0.1 millibar to about 400 millibar, about 0.1 millibar to about 300 millibar, about 0.1 millibar to about 200 millibar, about 0.1 millibar to about 100 millibar, about 0.2 millibar to about 1,000 millibar, about 0.2 millibar to about 900 millibar, about 0.2 millibar to about 800 millibar, about 0.2 millibar to about 700 millibar, about 0.2 millibar to about 600 millibar, about 0.2 millibar to about 500 millibar, about 0.2 millibar to about 400 millibar, about 0.2 millibar to about 300 millibar, about 0.2 millibar to about 200 millibar, about 0.2 millibar to about 100 millibar, about 100 millibar to about 1,000 millibar, about 100 millibar to about 900 millibar, about 100 millibar to about 800 millibar, about 100 millibar to about 700 millibar, about 100 millibar to about 600 millibar, about 100 millibar to about 500 millibar, about 100 millibar to about 400 millibar, about 100 millibar to about 300 millibar, about 100 millibar to about 200 millibar, about 200 millibar to about 1,000 millibar, about 200 millibar to about 900 millibar, about 200 millibar to about 800 millibar, about 200 millibar to about 700 millibar, about 200 millibar to about 600 millibar, about 200 millibar to about 500 millibar, about 200 millibar to about 400 millibar, about 200 millibar to about 300 millibar, about 300 millibar to about 1,000 millibar, about 300 millibar to about 900 millibar, about 300 millibar to about 800 millibar, about 300 millibar to about 700 millibar, about 300 millibar to about 600 millibar, about 300 millibar to about 500 millibar, about 300 millibar to about 400 millibar, about 400 millibar to about 1,000 millibar, about 400 millibar to about 900 millibar, about 400 millibar to about 800 millibar, about 400 millibar to about 700 millibar, about 400 millibar to about 600 millibar, about 400 millibar to about 500 millibar, about 500 millibar to about 1,000 millibar, about 500 millibar to about 900 millibar, about 500 millibar to about 800 millibar, about 500 millibar to about 700 millibar, about 500 millibar to about 600 millibar, about 600 millibar to about 1,000 millibar, about 600 millibar to about 900 millibar, about 600 millibar to about 800 millibar, about 600 millibar to about 700 millibar, about 700 millibar to about 1,000 millibar, about 700 millibar to about 900 millibar, about 700 millibar to about 800 millibar, about 800 millibar to about 1,000 millibar, about 800 millibar to about 900 millibar, or about 900 millibar to about 1,000 millibar.

In any aspect or embodiment described herein, the polyol resin comprises, consists essentially of, or consists of, the one or more (e.g., 1, 2, 3, 4, or more) polycaprolactone or polycaprolactone composition and a resin (e.g., an acrylic resin (such as a polyisocyanate cross-linking acrylic resin) and/or an epoxy resin). For example, in any aspect or embodiment described herein, the polyol resin comprises, consists essentially of, or consists of, the one or more (e.g., 1, 2, 3, 4, or more) polycaprolactone or polycaprolactone composition and a resin, wherein the resin comprises, consists essentially of, or consists of one or more (e.g., 1, 2, 3,4, or more) acrylic resin (e.g., a polyisocyanate cross-linking acrylic resin), one or more (e.g., 1, 2, 3,4, or more) epoxy resin, or mixture thereof. By way of further example, in any aspect or embodiment described herein, the polyol resin comprises, consists essentially of, or consists of, the one or more (e.g., 1, 2, 3, 4, or more) polycaprolactone or polycaprolactone composition and a resin, wherein the resin comprises, consists essentially of, or consists of one or more (e.g., 1, 2, 3, 4, or more) acrylic resin (e.g., a polyisocyanate cross-linking acrylic resin).

In any aspect or embodiment described herein, the polyol resin has a ratio of resin to one or more polycaprolactone or polycaprolactone composition of about 70:30 to about 95:5 (e.g., about 85:15 to about 95:5 or about 80:20 to about 90:10). For example, the polyol resin has a ratio of resin to one or more polycaprolactone or polycaprolactone composition of about 70:30 to about 95:5, about 70:30 to about 90:10, about 70:30 to about 85:15, about 70:30 to about 80:20, about 70:30 to about 75:25, about 75:25 to about 95:5, about 75:25 to about 90:10, about 75:25 to about 85:15, about 75:25 to about 80:20, about 80:20 to about 95:5, about 80:20 to about 90:10, about 80:20 to about 85:15, about 85:15 to about 95:5, about 85:15 to about 90:10, or about 90:10 to about 95:5.

### EXAMPLES

Polycaprolactone polyols have emerged as a pivotal component in the arsenal of coating formulators, offering a multitude of enhancements to coating systems. These benefits range from improved abrasion and scratch resistance to notable scratch recovery capabilities (Jones, C. (2024). Improved 2K-Polyurethane Coatings with Polycaprolactone Polyols. PCI Magazine. Vol. 40, No. 2). Three-functional polycaprolactone polyols, or triols, can provide an optimal balance between hardness and flexibility, thereby positioning them as a material of choice for achieving desired performance characteristics in coatings.

Considering escalating environmental and regulatory concerns, it is imperative to maintain vigilance regarding the raw materials employed in polymers. The health and safety impacts of these materials are of paramount importance. Trimethylolpropane (TMP), a material traditionally utilized in a broad spectrum of industrial applications that includes the manufacture of polyols, has come under scrutiny due to potential reprotoxic effects. However, due to the regulatory position of trimethylolpropane (TMP) being reclassified as a reproductive toxicant, an alternative initiator is required for production of polycaprolactones for use in urethane compositions.

### Example 1. Synthesis of Polycaprolactones of the Present Disclosure

Exemplary polycaprolactones Label-Free Polycaprolactone 1 (LFPCL-1; 300 MW) and Label-Free Polycaprolactone 2 (LFPCL-1; 500 MW) was prepared by ring opening polymerisation of caprolactone monomers in the presence of a catalyst and an initiator comprising at least one secondary hydroxyl group as described herein to achieve the specified molecular weight. The reaction is conducted using typical conditions and catalysts known in the art to prepare polycaprolactone (PCL).

The characteristics of the LFPCL-1 (300 MW) and LFPCL-2 (500 MW) are shown in Table 1.

### Example 2. Preparation of Solvent-Borne 2K Polyurethane

A commercially available acrylic resin (SETALUX® D A 870 BA (allnex; Frankfurt, Germany)) was utilized (70% solid content, <50 Hazen color, acid value of 7.5±1.5 mg KOH/g, and a viscosity of 3.5 Pa·s at 25° C.) as the main resin in the exemplary solvent-borne 2K polyurethane formulation described herein. Comparative polyols were chosen as benchmarks for the examination of the LFPCL-1 (300 MW) and LFPCL-2 (500 MW), including commercially available 300 MW trimethylolpropane (TMP) polycaprolactone (TMPPCL-1; Ingevity UK LTD; Warrington, United Kingdom), 500 MW trimethylolpropane (TMP) polycaprolactone (TMPPCL-2; Ingevity UK LTD; Warrington, United Kingdom), a commercially available 300 molecular weight trimethylolpropane (TMP) containing polycaprolactone triol (CTMPPCL-1), a commercially available 400 molecular weight polyether diol (400 MW PE), and a commercially available 500 molecular weight polyester adipate diol (500 MW PS). The physical properties of the benchmark polyols, LFPCL-1 (300 MW), and LFPCL-2 (500 MW) are shown in Table 1.

TABLE 1
Physical properties of materials tested.

| | | | | Hydroxyl | |
|---|---|---|---|---|---|
| | | | | Value | Viscosity |
| | Molecular | Polyol | Solid | (mg | at 25° C. |
| Material | Weight | Type | Content | KOH/g) | (cP) |
| Acrylic Resin | 1150 | Acrylic diol | 70% | 98 | 3500 |
| TMPPCL-1 | 300 | TMP Initiated | 100% | 1560 | 1800 |
| | | Polycaprolactone | | | |
| | | triol | | | |
| TMPPCL-2 | 500 | TMP Initiated | 100% | 311 | 1200 |
| | | Polycaprolactone | | | |
| | | triol | | | |
| LFPCL-1 | 300 | Label-Free | 100% | 545 | 600 |
| | | Polycaprolactone | | | |
| | | triol | | | |
| LFPCL-2 | 500 | Label-Free | 100% | 316 | 900 |
| | | Polycaprolactone | | | |
| | | triol | | | |
| CTMPPCL-1 | 300 | Commercial | 100% | 540 | 1400 |
| | | Polycaprolactone | | | |
| | | triol | | | |
| 400 MW PE | 400 | Polyether Diol | 100% | 260 | 700 |
| 500 MW PS | 500 | Polyester | 100% | 600 | 600 |
| | | Adipate Diol | | | |

Solvent-borne two-component (2K) polyurethane coating were prepared according to the formulations in Table 2. In particular, solvent-borne 2 k polyurethane formulations were examined: a 90:10 ratio of the acrylic resin to the polyol (PU Formulation 1, PU1, or Mod 1) and an 80:20 ratio of the acrylic resin to the polyol (PU Formulation 2, PU2. Mod 2). A Control without a polyol was prepared. The 2K solvent-borne polyurethane formulations are shown in Table 2.

TABLE 2
Solvent-borne 2K polyurethane formulation

| | | PU | PU |
|---|---|---|---|
| | | Formulation 1 | Formulation 2 |
| | | (wt %) | (wt %) |
| Part | Arylic Resin (acrylic polyl with 4.2% OH) | 50.0-55.5 | 38.5-46.5 |
| A | Polyol | 5.5-6.5 | 9.5-11.5 |
| | Defoamer (silicone-based polymeric defoamer) | 0.8 | 0.8 |
| | Flow Additive (polyether-modified | 0.3 | 0.3 |
| | polydimethylsiloxane solution) | | |
| | Organotin Catalyst | 0.1 | 0.1 |
| | Wetting Agent (dipropylene glycol | 1.5 | 1.5 |
| | monobutylether) | | |
| | Butyl acetate/xylene/methoxy propanol (1:1:1) | 7.0-8.0 | 9.5-10.5 |
| Part | Hexamethylene diisocyanate | 23.0-27.5 | 24.0-31.5 |
| B | Butyl acetate/xylene/methoxy propanol (1:1:1) | 5.0-6.0 | 5.0-7.0 |

The formulations were modified according to the amount of acrylic resin, polyol, and isocyanate present to maintain a ratio of NCO:OH in the formulation at 1.05:1. The amount of solvent added to the formulation was adjusted, to ensure all formulations had a mixed solids content of 70% by weight.

### Example 3. Evaluation Solvent-Borne 2K Polyurethane Topcoat from Example 2

Testing was conducted on the wet coatings and on drawn down panels. The panels were applied using a Baker bar and an automatic film applicator, each from TQC Sheen (Rotterdam, Netherlands), with a wet film thickness of 150 microns, giving a nominal dry film thickness of 70 to 80 microns. Prior to testing, the panels were allowed to cure and conditioned for 7 days at 23±2° C. at 50±5% relative humidity.

TABLE 3
Substrate Panels used for Testing

| | | | Dry Film |
|---|---|---|---|
| Test | Substrate | | Thickness |
| Procedure | (Type) | Physical Test | (μm) |
| ISO 9117- | Black chart | Dry time determination | 70-80 |
| 4:2012 | (Leneta Form | | |
| | BH) | | |
| ISO | Glass | Gloss | 70-80 |
| 2813:2014 | (Rocholl) | | |
| ISO | Aluminium | Mandrel Bend | 70-80 |
| 6860:2006 | (Q Lab A-48) | | |
| ISO 6272- | Aluminium | Impact resistance | 70-80 |
| 1:2011 | (Q Lab A-48) | | |
| ISO 1518- | Mild Steel | Scratch Resistance | 70-80 |
| 1:2023 | (Q Lab R-36) | | |
| ISO | Mild Steel (Q | Cross-cut | 70-80 |
| 2409:2020 | Lab R-36) | | |
| | Polycarbonate | | |
| | Plastic (Rocholl) | | |
| ISO | Glass (Rocholl) | Pendulum Hardness | 70-80 |
| 1522:2022 | | | |
| Method | Glass (Rocholl) | Abrasion and Self Heal | 70-80 |
| Described | | | |
| below | | | |
| ASTM | Opacity Chart | Chemical and Stain | 70-80 |
| D1308-20 | (Leneta Form | Resistance | |
| | 5C) | | |
| ASTM | Mild Steel | Taber Abrasion | 70-80 |
| D4060-19 | (Taber S-16) | | |

Determination of Drying Time (ISO 9117-4:2012 (Paints and varnishes—Drying tests, Part 4: Test using, a mechanical recorder). Dry-time was examined by drawdown application and panels were placed immediately onto a TQC Sheen drying time recorder following ISO 9117-4:2012.

Determination of Film Thickness (ISO 2808:2019 (Paints and varnishes—Determination of film thickness)). Panels were checked for dry film thickness using a Defelsko Positest gauge. An average was taken of 5 measurements in different areas of the panel.

Determination of Specular Gloss (ISO 2813:2014 (Paints and varnishes—Determination of gloss value at 20°, 60° and 85°)). Gloss was measured using a handheld gloss meter, TQC sheen master paint plate multi-tester. An average was taken of 5 measurements in different areas of the panel.

Rapid Deformation Impact Resistance Test (ISO 6272-1:2011 (Paints and varnishes—Rapid-deformation (impact resistance) tests, Part 1: Falling-weight test, large-area indenter)). The impact tester weight was raised to 50 cm in one area of each panel and 100 cm in another area of the same panel and dropped directly onto each coated panel. The panels were then evaluated.

Conical Mandrel (ISO 6860:2006 (Paints and varnishes—Bend test (conical mandrel))). The panels were bent using the TQC bend test conical mandrel, and microscopically analyzed for cracks and deformations within the film.

Taber Abrasion (ASTM D4060-19 (Standard Test Method for Abrasion Resistance of Organic Coatings by the Taber Abraser)). Specific Taber Abrasion mild steel panels (Taber S-16) were degreased with methyl ethyl ketone (MEK) before applying the different coatings. Each panel was subjected to Taber testing according to ASTM D4060-19 using Taber® Model 1750 (North Tonawanda, New York), using CS-17 wheels and 1 kg weights. Each panel was pre-weighed then subjected to 500 cycles of abrasion, and each sample was weighed after 500 cycle intervals. The results are reported as a Taber Wear Index (I) using the following calculation:

$$I = \frac{( A - B ) 1000}{C}$$

where:
A=weight of test specimen before abrasion in milligrams (mg),
B=weight of test specimen after abrasion in mg, and
C=number of cycles of abrasion recorded.

Determination of Viscosity: Using a rheometer. The viscosity of the wet polyol was determined for using a TA Instruments Discovery HR10 rheometer (New Castle, Delaware). The method used a standard aluminium Peltier plate, 25 mm in diameter. The polyol was conditioned for 60 seconds at 25° C. and then a flow peak hold was applied for 60 seconds with a shear rate of 1.0 1/s and a sampling interval of 0.5 s/pt.

Erichsen Linear Scratch Resistance Testing (ISO 1518-1:2023 (Paints and varnishes—Determination of scratch resistance, Part 1: Constant-loading method)). Each panel was clamped on the mobile slide of Erichsen 249 Linear Tester. Above this and held by two metal pillars, is a reciprocating beam bedded in a free-moving manner with an adaptor set holding a 1 mm ISO d1 spherical insert test tip. This tip was lowered onto the panel with no force (weight) applied to the panel and then clamped in place. Increasing scratch forces (N) were applied in adjacent areas of each panel by moving the panels sideways, to show the effect of increasing scratch forces on each panel. This is achieved by moving the load weight (40N) along the weight beam, increasing the load each time from 10N to 26N, going up in 2N intervals.

Cross-cut Test (ISO 2409:2020 (Paints and varnishes—Cross-cut test)). Adhesion of the coatings to the various substrates were measured according to ISO 2409. Each testing panel was cut with a knife using a crosshatch cutter. Tape was then applied onto the test area and pulled off rapidly. The test area was then inspected visually, using the below rating system.

TABLE 4
Scoring system for cross-cut test

| | |
|---|---|
| 0 | None of the squares of the lattice is detached |
| 1 | A cross-cut area not greater than 5 % is affected |
| 2 | A cross-cut area greater than 5 %, but not greater than 15 %, is |
| | affected |
| 3 | A cross-cut area greater than 15 %, but not greater than 35%, is |
| | affected |
| 4 | A cross-cut area greater than 35 %, but not greater than 65 %, is |
| | affected |
| 5 | Any degree of flaking that cannot even be classified by |
| | classification 4 |

König Pendulum Hardness Test (ISO 1522:2022 (Paints and varnishes—Pendulum damping test)). Each panel was placed into the TQC Sheen Pendulum Hardness Tester and tested according to ISO 1522:2022 using a König oscillating pendulum. The pendulum is set in oscillation according to the specified angle for each pendulum. The instrument then measures the number of counts and time period in which the oscillation amplitude drops to a certain level.

Determination of Pot life: Using a viscometer. The pot life of the coating formulations were determined using a TA Instruments Discovery HR10 rheometer (New Castle, Delaware) with a standard aluminium Peltier plate at 252° C., indicating pot-life to be when viscosity doubles the initial viscosity.

Chemical Resistance Testing (ASTM D1308-20 (Standard Test Method for Effect of Household Chemicals on Clear and Pigmented Coating Systems)). A spot test method was used to evaluate the chemical resistance of each panel. A small amount (spot) of each chemical was applied in each designated area of each panel using a pipette. Each chemical spot was then covered with a small glass vial to contain any potential vapors produced by the chemicals during the experiment. Observations of each spot were scored according to Table 5 at the time specified in the data table.

TABLE 5
Scoring system used for each physical test

| | |
|---|---|
| 5 | No Visual or microscopic defects |
| 4 | No Visual defects, some microscopic defects |
| 3 | Some slight visual and microscopic defects |
| 2 | Obvious visual and microscopic defects |
| 1 | Severe visual and microscopic defects |
| 0 | Complete failure/adhesion loss/substrate visible |

The following chemicals used for chemical resistance testing: 95% acetone, 99% methanol, mustard (1-2% allyl isothiocyanate, 50-60% water, 5-10% acetic acid, 1-2% sodium chloride, and 1-5% spices and flavorings), olive oil, coffee (>80 g/L freeze dried coffee in water solution), and water.

Examination of Abrasion and Self-Heal. Abrasion and self-healing of the coatings was examined using an in-house test method. After coating, the panels were allowed to cure for 7 days at 23° C. at 50% relative humidity. The specular gloss, at a 600 angle, was measured using a TQC Sheen Glossmeter for each test area in three areas. Each test area was subjected to 10 double rubs of an abrasive media using an Erichsen 249 Linear Tester. A 10N load weight was used to add force, at a speed of 45 mm/s. Gloss was measured in the same three areas after 10 double rubs and then each panel was placed into an oven set at 50° C. for a total of 5 minutes. Gloss was measured after the panel had been removed from the oven, in the same three areas and reported. The test areas were subjected to this process in triplicate.

Examination of Dynamic Mechanical Analysis (DMA). DMA was determined on the coating films using a TA Instruments DMA 850 in tension mode, with a dual screw film clamp, a temperature range of −30° C. to 130° C. at a ramp rate of 3° C./min and a strain of 0.1%, at 1 Hz. A preload force of 0.05N was used and a force track of 150%. The coating films were subjected to this process in triplicate.

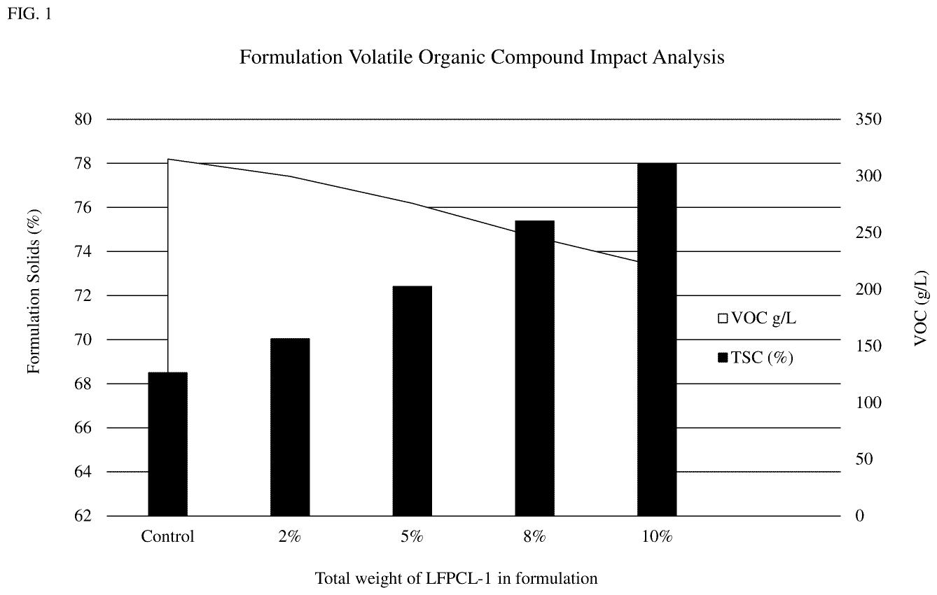

Volatile Organic Compound Impact. In response to increasing regulatory and environmental pressures, reducing volatile organic compound (VOC) emissions in solvent-borne coatings has become a critical objective for formulators. Partial replacement of lower-solids, higher-viscosity resins—such as acrylic diols—with high-solids, low-viscosity alternatives like polycaprolactone polyols, have proven to be an effective strategy. FIG. 1 highlights the impact of incorporating a novel 100% solids, label-free polycaprolactone triols into a 2K polyurethane formulation, replacing the acrylic resin at incremental levels of 2%, 5%, 8%, and 10% by weight.

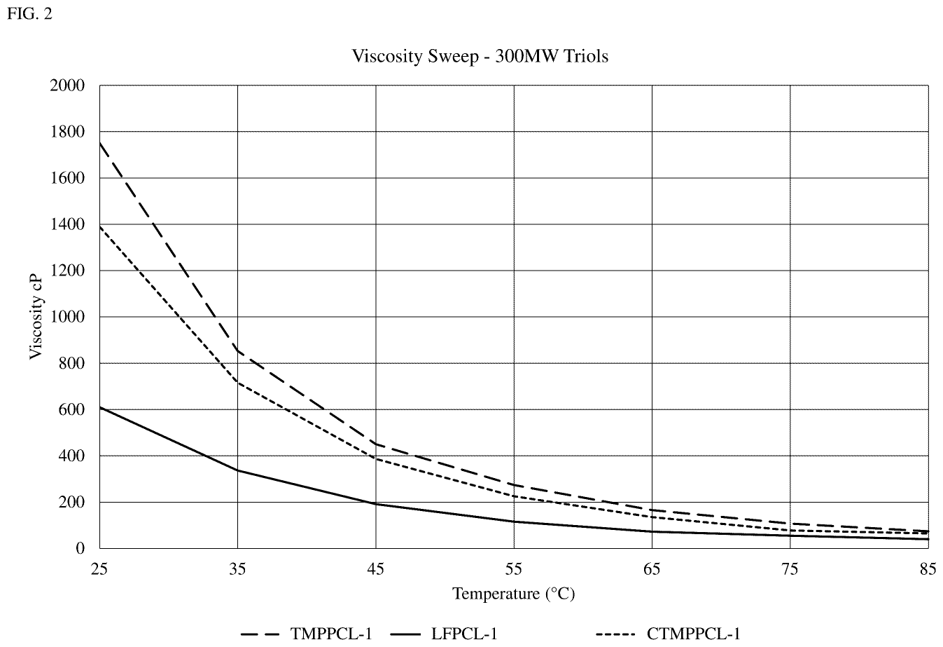

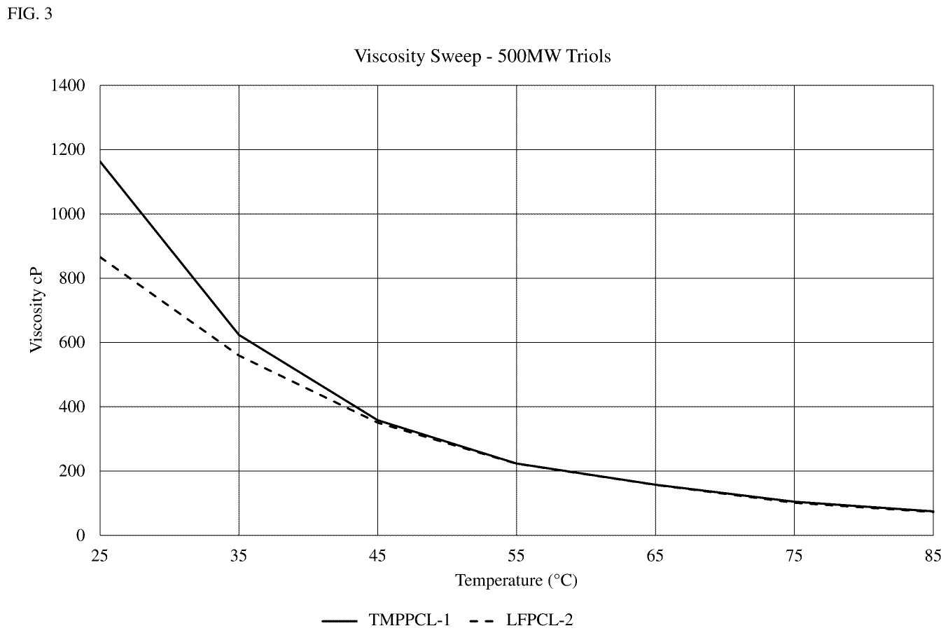

Viscosity Results. The viscosities of the polycaprolactone triols were measured from 25° C. up to 85° C. A significant difference in viscosity was observed between the three 300MW polycaprolactone triols (FIG. 2) with LFPCL-1 having a much lower viscosity with increasing temperature, as compared to existing triol chemistries based on TMP. A noticeable difference in viscosity was observed between the 500MW polycaprolactone triols (FIG. 3) with LFPCL-2 having a lower viscosity compared to TMPPCL-2 up to 55° C.

The viscosities of Part A of the PU Formulation 1 (PU1) of the exemplary polyurethanes were measured at 25° C. and are shown in Table 6, shown in order of increasing viscosity. Overall, when a polyol is incorporated into the polyurethane formulation, a significant decrease in viscosity was observed. The polyol that has the highest reduction in viscosity is LFPCL-1 when formulated to equivalent solids level. This is due to initial viscosity reduction imposed by the difference in viscosity to that of the base acrylic resin, and so, addition of solvent to match solids, has dramatic viscosity reduction impact. This impact is more noticeable with novel label-free low molecular weight triols, as compared to TMP-based polycaprolactone triols.

TABLE 6
Viscosities of Part A of exemplary polyurethane
formulations, at 25° C.

| | Viscosity of |
|---|---|
| | Part A at 25° C. |
| Formulation | (cP) |
| LFPCL-1-PU1 Formulation | 930 |
| 400MW PE-PU1 Formulation | 1160 |
| TMPPCL-1-PU1 Formulation | 1360 |
| CTMPPCL-2-PU1 Formulation | 1400 |
| LFPCL-2-PU1 Formulation | 1470 |
| TMPPCL-2-PU1 Formulation | 1470 |
| 500MW PS-PU1 Formulation | 1560 |
| Control | 14060 |

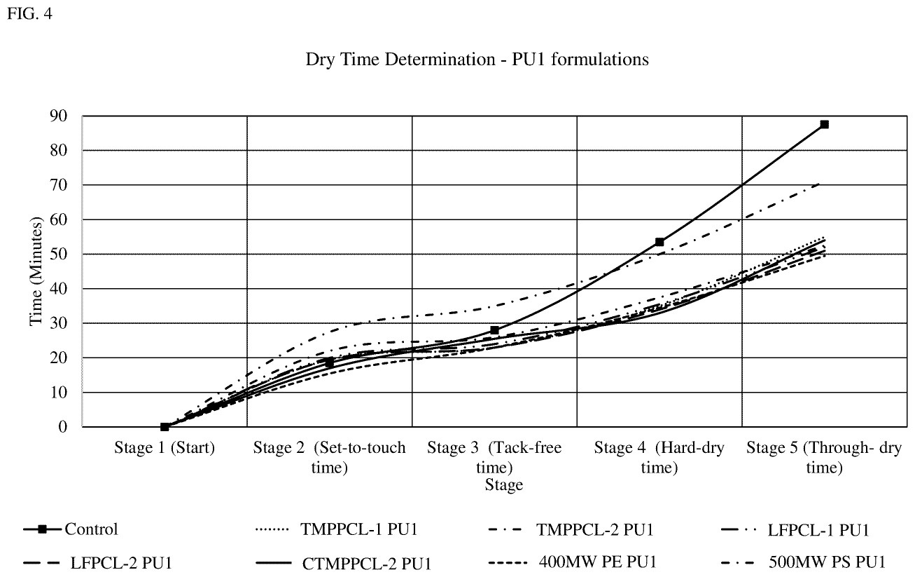

Pot-Life and Dry Time Results. The Control exhibited the shortest pot-life and took the longest time to achieve hard-dry time and through-dry time, as seen in Table 7 (shown in order of increasing pot-life) and FIG. 4. By increasing the amount of polyol within the formulation, the pot-life time is extended for all formulations (Table 7).

The LFPCL-1 PU2 formulation shows a greater increase in pot-life, when compared to the TMP-containing 300MW polycaprolactone Formulation 2 (TMPPCL-1—PU2 and CTMPPCL-1—PU2), as seen in Table 7. The hard-dry time and through-dry time is notably faster when increasing the amount of LFPCL-1 and LFPCL-2 in the formulation (FIG. 4).

TABLE 7
Pot-life determination and dry time results of
exemplary polyurethane formulations

| | Time (s) to double |
|---|---|
| Material | in viscosity (s) |
| PU1 Formulations | |
| Control | 205 |
| 400MW PE PU1 | 254 |
| TMPPCL-2 PU1 | 258 |
| LFPCL-2 PU1 | 264 |
| LFPCL-1 PU1 | 279 |
| CTMPPCL-1 PU1 | 286 |
| TMPPCL-1 PU1 | 299 |
| 500MW PS PU1 | 357 |
| PU2 Formulations | |
| Control | 205 |
| TMPPCL-2 PU2 | 273 |
| TMPPCL-1 PU2 | 297 |
| CTMPPCL-1 PU2 | 298 |
| LFPCL-1 PU2 | 342 |
| LFPCL-2 PU2 | 358 |
| 400MW PE PU2 | 384 |
| 500MW PS PU2 | 388 |

Research into the mechanistic effect of caprolactone triols on curing profile of coatings systems shows that the incorporation of a low molecular weight caprolactone triols into the polyurethane formulation appears to influence both pot life and drying behaviour through a combination of steric and dynamic viscosity effects. Initially, the high functionality and compact structure of the triol may lead to localized steric hindrance, reducing the accessibility of hydroxyl groups to isocyanate functionalities. This steric congestion can delay the onset of crosslinking, thereby extending the pot life of the formulation (Saunders, J. H. (1962). Polyurethanes: Chemistry and Technology, Part I. Interscience Publishers; Randall, D. and Lee, S. (2002). The Polyurethanes Book. Wiley Ltd. New York).

As the reaction progresses, the growing polymer network alleviates some of this steric hindrance, allowing previously inaccessible hydroxyl groups to participate in the reaction. This results in an acceleration of the crosslinking rate, particularly in the later stages of curing (Arnould, P. S. (2022). Harnessing catalysis selectivity and isophorone diisocyanate asymmetry for tailored polyurethane prepolymers and networks. Macromolecules, 55(8), 3344-3352). Concurrently, the low molecular weight of the caprolactone triol contributes to a lower initial viscosity, which delays gelation. However, once a critical conversion is reached, the high functionality of the triol drives rapid network formation, leading to a sharp increase in viscosity and solidification (de Souza, F. M. (2021). Materials and Chemistry of Flame-Retardant Polyurethanes, Volume 1. A fundamental approach, Chapter 1. Materials and Chemistry of Polyurethanes. American Chemical Society, Washington, D.C.).

### Physical Test Results.

TABLE 8
Physical test results of polyurethane formulations according to the PUI formulation

| | | TMPPCL- | TMPPCL- | LFPCL- | LFPCL- | CTMPPCL- | 400 MW | 500 MW |
|---|---|---|---|---|---|---|---|---|
| | Control | 1 | 2 | 1 | 2 | 1 | PE | PS |
| Gloss 60° (G.U) | 143 | 144 | 145 | 144 | 143 | 143 | 143 | 144 |
| Mandrel Bend | Fail | Pass | Pass | Pass | Pass | Pass | Pass | Pass |
| Impact | 30 | 60 | 70 | 80 | 80 | 80 | 70 | 60 |
| Resistance- | | | | | | | | |
| Point of failure | | | | | | | | |
| (cm) | | | | | | | | |
| Scratch | 10 | 26 | 24 | 26 | 28 | 20 | 24 | 20 |
| Resistance- | | | | | | | | |
| Minimum load | | | | | | | | |
| (N) | | | | | | | | |
| Crosshatch | 5 | 0 | 0 | 0 | 0 | 0 | 0 | 0 |
| Adhesion-Mild | | | | | | | | |
| Steel | | | | | | | | |
| Crosshatch | 5 | 5 | 5 | 5 | 5 | 5 | 5 | 5 |
| Adhesion- | | | | | | | | |
| Polycarbonate | | | | | | | | |
| Plastic | | | | | | | | |
| Chemical/Stain | 5 | 5 | 5 | 5 | 5 | 5 | 5 | 5 |
| Resistance- | | | | | | | | |
| Acetone 10 s | | | | | | | | |
| Chemical/Stain | 5 | 5 | 5 | 5 | 5 | 5 | 5 | 5 |
| Resistance- | | | | | | | | |
| Methanol 1 hour | | | | | | | | |
| Chemical/Stain | 2 | 2 | 2 | 2 | 2 | 2 | 2 | 2 |
| Resistance- | | | | | | | | |
| Mustard 6 hours | | | | | | | | |
| Chemical/Stain | 5 | 5 | 5 | 5 | 5 | 5 | 5 | 5 |
| Resistance- | | | | | | | | |
| Olive oil 16 hours | | | | | | | | |
| Chemical/Stain | 5 | 5 | 5 | 5 | 5 | 5 | 5 | 5 |
| Resistance- | | | | | | | | |
| Coffee 16 hours | | | | | | | | |
| Chemical/Stain | 5 | 5 | 5 | 5 | 5 | 5 | 5 | 5 |
| Resistance- | | | | | | | | |
| Water 24 hours | | | | | | | | |

TABLE 9
Physical test results of polyurethane formulations according to the PU2 formulation

| | | TMPPCL- | TMPPCL- | LFPCL- | LFPCL- | CTMPPCL- | 400 MW | 500 MW |
|---|---|---|---|---|---|---|---|---|
| | Control | 1 | 2 | 1 | 2 | 1 | PE | PS |
| Gloss 60° (G.U) | 143 | 142 | 143 | 142 | 142 | 144 | 143 | 140 |
| Mandrel Bend | Fail | Pass | Pass | Pass | Pass | Pass | Pass | Pass |
| Impact | 30 | 60 | 70 | 60 | 70 | 70 | 70 | 60 |
| Resistance- | | | | | | | | |
| Point of failure | | | | | | | | |
| (cm) | | | | | | | | |
| Scratch | 10 | 24 | 20 | 26 | 26 | 16 | 22 | 20 |
| Resistance- | | | | | | | | |
| Minimum load | | | | | | | | |
| (N) | | | | | | | | |
| Crosshatch | 5 | 0 | 0 | 0 | 0 | 0 | 0 | 0 |
| Adhesion-Mild | | | | | | | | |
| Steel | | | | | | | | |
| Crosshatch | 5 | 5 | 5 | 5 | 5 | 5 | 5 | 5 |
| Adhesion- | | | | | | | | |
| Polycarbonate | | | | | | | | |
| Plastic | | | | | | | | |
| Chemical/Stain | 5 | 5 | 5 | 5 | 5 | 5 | 5 | 5 |
| Resistance- | | | | | | | | |
| Acetone 10 s | | | | | | | | |
| Chemical/Stain | 5 | 5 | 5 | 5 | 5 | 5 | 5 | 5 |
| Resistance- | | | | | | | | |
| Methanol 1 hour | | | | | | | | |
| Chemical/Stain | 2 | 1 | 1 | 1 | 1 | 1 | 1 | 1 |
| Resistance- | | | | | | | | |
| Mustard 6 hours | | | | | | | | |
| Chemical/Stain | 5 | 5 | 5 | 5 | 5 | 5 | 5 | 5 |
| Resistance- | | | | | | | | |
| Olive oil 16 hours | | | | | | | | |
| Chemical/Stain | 5 | 5 | 5 | 5 | 5 | 5 | 3 | 3 |
| Resistance- | | | | | | | | |
| Coffee 16 hours | | | | | | | | |
| Chemical/Stain | 5 | 5 | 5 | 5 | 5 | 5 | 5 | 5 |
| Resistance- | | | | | | | | |
| Water 24 hours | | | | | | | | |

The physical test results for the Control and the PU1 formulations shown in Table 8. The physical test results for the Control and the PU2 formulations shown in Table 9.

The gloss values for all formulations are similar and are comparable to the control formulation (Control).

All PU1 formulations and PU2 formulations passed the mandrel bend flexibility test showing no signs of cracking or delamination of the coating. The control formulation (Control) failed due to the coating delaminating from the substrate along the entire length of the panel. Impact Resistance results show the control formulation (Control) has the lowest point of failure at 30 cm. The addition of a polycaprolactone polyol to the formulation does significantly increase the impact resistance, in particular with the label-free triols (LFPCL-1 and LFPCL-2) having the highest point of failure at 80 cm, largely due to the low Tg nature of these polyols. However, by increasing the amount of polyol within the formulation from PU1 to PU2 formulations, the impact resistance values did not increase and instead either stayed the same or decreased slightly, suggesting a point of diminishing return for addition polycaprolactone polyols as a co-binder in formulation systems containing Acrylic as the main polyol. The control formulation (Control) had the worst scratch resistance at a minimum penetration load of 10N. The addition of a polycaprolactone polyol to the formulation significantly increases the scratch resistance, with LFPCL-2 PU1 formulation having the best scratch resistance at a maximum penetration load of 28N before coating failure. However, by increasing the amount of polyol within the formulation from PU1 to PU2 formulations, the scratch resistance values either stayed the same or decreased slightly.

All formulations failed crosshatch adhesion testing on polycarbonate substrates. The control formulation (Control) failed crosshatch adhesion testing on the mild steel, while all other formulations passed on the mild steel, showing no removal of the coating from the substrate, suggesting addition of novel label-free polycaprolactone polyols as a viable option for improvement or retention of adhesion properties for direct to metal coatings.

The chemical and stain resistance results show that all formulations passed the acetone, methanol, olive oil, and water spot tests. All formulations observed staining from the mustard spot test, with the control formulation (Control) and all PU1 formulations showing obvious staining and all PU2 formulations showing severe staining. The 400MW PE PU2 formulation and 500MW PS PU2 formulation observed some slight staining from the coffee spot test. For certain formulations, the addition of more polyol can decrease the stain resistance of the coating.

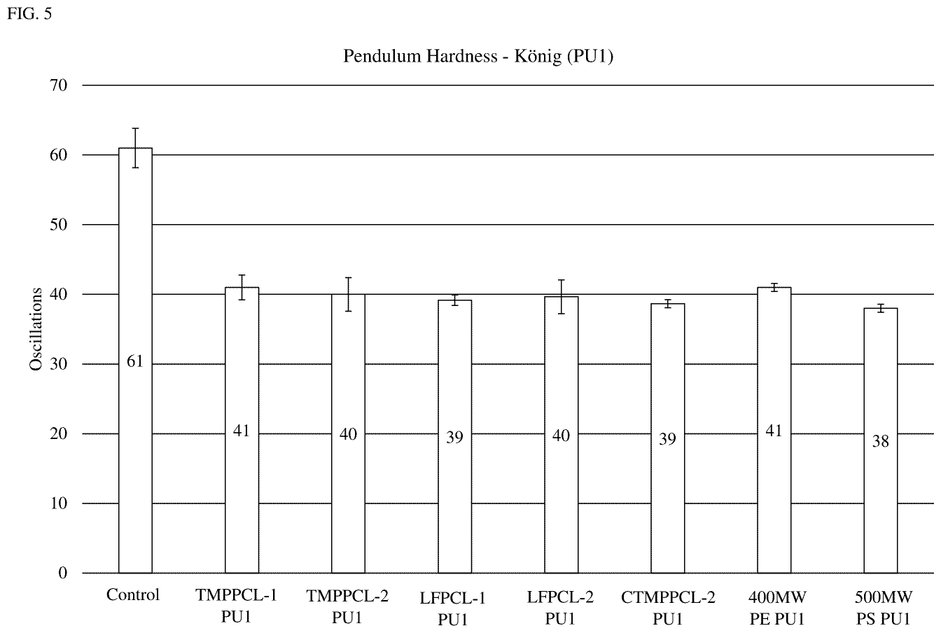

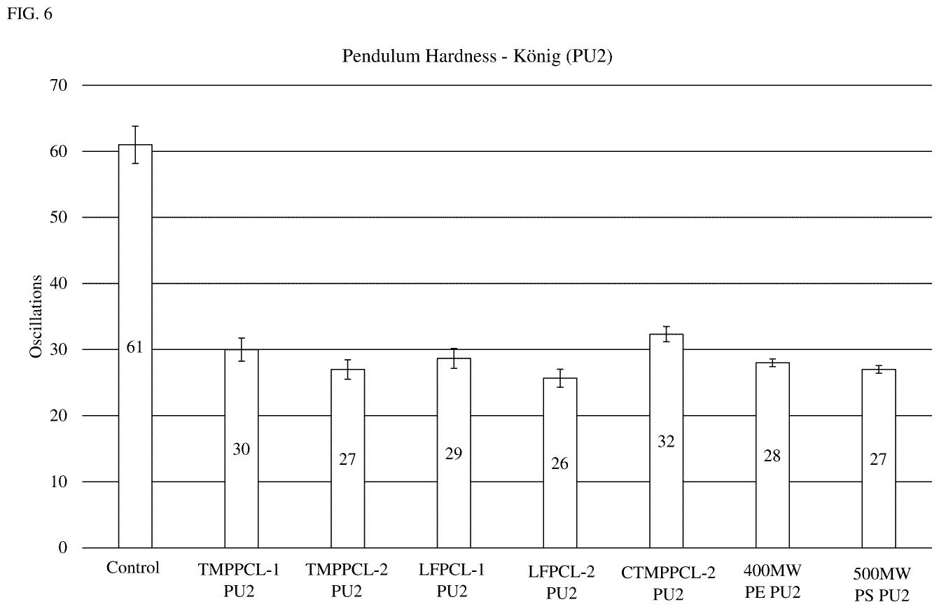

König Pendulum Hardness Results. The König pendulum hardness results for the control formulation (Control) and PU1 formulations are shown in FIG. 5. The König pendulum hardness results for the control formulation (Control) and PU2 formulations are shown in FIG. 6. The results show that the addition of a polycaprolactone polyol into the formulation reduces the hardness of the coating and the more polyol added, the bigger the reduction in hardness and the softer the coating becomes. All PU1 formulations have a similar hardness value of around 40 oscillations and all PU2 formulations have a comparable hardness value of between 26 and 32 oscillations. More importantly, no differences were noted when comparing hardness of traditional TMP-based polyols against novel label-free versions thereof.

Although the incorporation of caprolactone polyols into the acrylic matrix results in a measurable reduction in coating hardness, this does not compromise, and even enhances, abrasion and scratch resistance. This can be attributed to the increased flexibility and energy dissipation capacity of the polycaprolactone domains, which help absorb and redistribute mechanical stress. Similar behavior has been reported in PLA/PCL systems for bioplastics applications, where reduced stiffness was accompanied by improved toughness and surface durability (Qinghua Wei, (2021). Research on the miscibility, mechanical properties and printability of polylactic acid/poly (ε-caprolactone) blends: insights from molecular dynamics simulation and experiments. Journal of Materials Science, 56, 9754-9768). This combined with the low molecular weight and elevated hydroxyl value of the caprolactone triols contribute to a higher density of urethane linkages, forming additional hard segments within the polymer matrix. These segments enhance abrasion and scratch resistance, even when overall coating hardness is reduced (Senichev, V. (2023). Relationship between the Abrasion Resistance of Urethane-Containing Elastomers and Their Structure. Polymer Science, Series D, 16, 549-552).

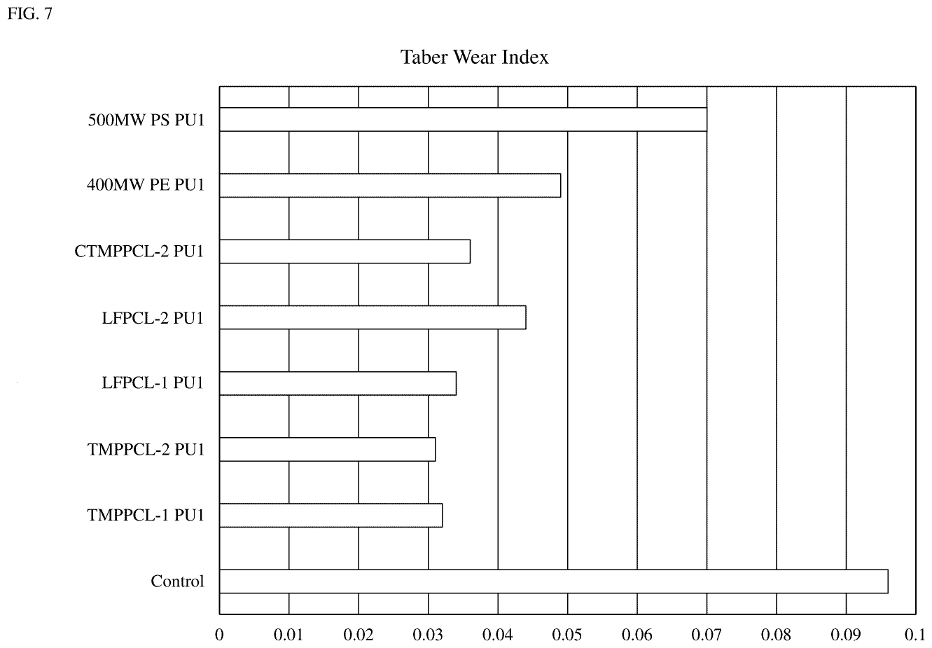

Abrasion Resistance Results. The addition of a polyol as a partial replacement of the acrylic into the formulation improves the abrasion resistance of the coating (FIG. 7). The control formulation (Control) exhibited the worst abrasion resistance with a Taber Wear Index (TWI) of 0.96. The best abrasion resistance of the formulations was observed for the TMPPCL-1 PU1 formulation, TMPPCL-2 PU1 formulation, and LFPCL-1 PU1 formulation (FIG. 7), demonstrating that the novel label-free polycaprolactone triols of the present disclosure can retain durability benefits whilst being safer to handle.

Abrasion and Self-Heal Results. Abrasion and self-heal results after one test cycle for all formulations are shown in Table 10. The control formulation (Control) exhibited the lowest self-healing performance, achieving 66% gloss recovery after one cycle. The addition of a polyol into the formulation improved the self-healing performance of the coating. When additional polyol is added into the formulation, there is a further increase in self-heal performance for all formulations. Formulations containing Exemplary Polycaprolactone 1 had the best self-healing performance after one test cycle, achieving 90% gloss recovery for PU1 and 96% gloss recovery for PU2.

TABLE 10
Abrasion and Self-Heal results of the polyurethane
formulations, after 1 testing cycle

| | | Gloss | Gloss | |
|---|---|---|---|---|
| | | after 10 | after 5 | |
| | Gloss | double | minutes | |
| | before | rubs | at 50° C. | Gloss |
| Sample | (G.U) | (G.U) | (G.U) | Recovery |
| Control | 139 | 82 | 91 | 66% |
| PU1 Formulations | | | | |
| TMPPCL-1 | 143 | 109 | 125 | 87% |
| TMPPCL-2 | 143 | 108 | 126 | 88% |
| LFPCL-1 | 142 | 112 | 128 | 90% |
| LFPCL-2 | 142 | 111 | 126 | 89% |
| CTMPPCL-1 | 143 | 98 | 120 | 84% |
| 400MW PE | 144 | 105 | 125 | 87% |
| 500MW PS | 144 | 82 | 111 | 77% |
| PU2 Formulations | | | | |
| TMPPCL-1 | 142 | 112 | 132 | 93% |
| TMPPCL-2 | 144 | 106 | 133 | 92% |
| LFPCL-1 | 143 | 104 | 136 | 96% |
| LFPCL-2 | 141 | 108 | 136 | 95% |
| CTMPPCL-1 | 144 | 111 | 137 | 95% |
| 400MW PE | 145 | 111 | 131 | 90% |
| 500MW PS | 140 | 100 | 130 | 93% |

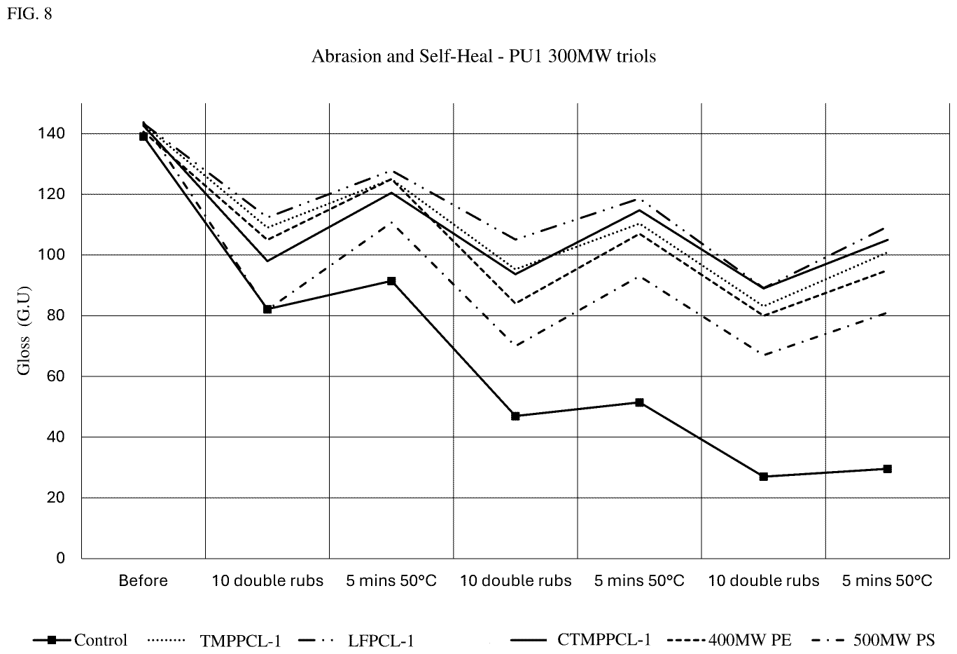

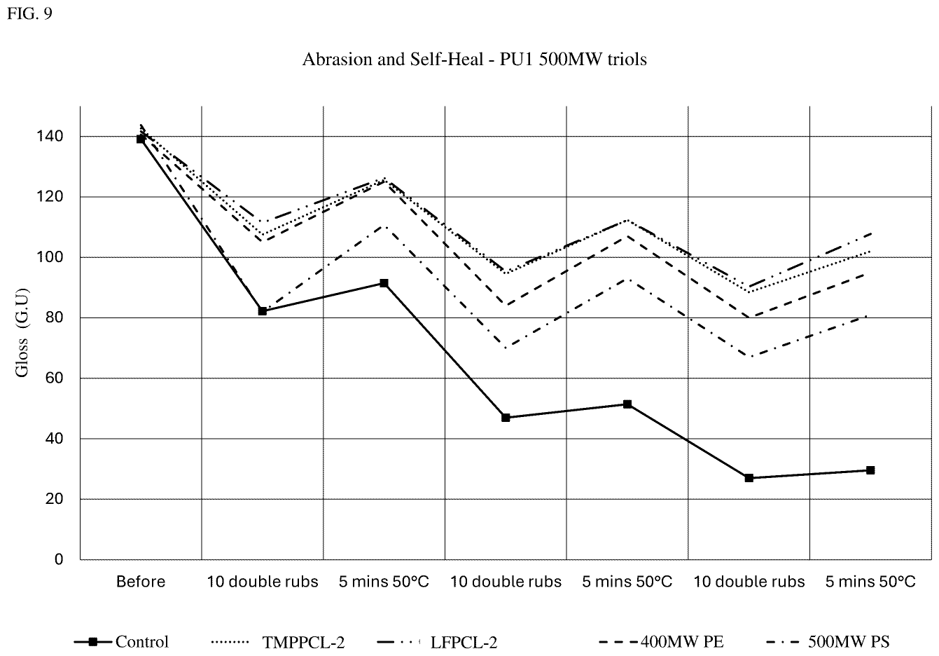

The control formulation (Control) exhibited the lowest self-healing performance, achieving 21% gloss recovery after three cycles (FIGS. 8 and 9). The addition of a polyol into the formulation enhanced the self-healing properties of the coatings. The formulation containing novel label-free polycaprolactone triols exhibited equivalent or slightly better self-healing characteristics over multiple test cycles compared to TMP based polycaprolactone triols. In all cases, polycaprolactone triols exhibited significantly better self-healing properties over polyester or polyether resins of equivalent or similar molecular weight. LFPCL-1 had the best self-healing performance, achieving 76% gloss recovery after three cycles.

Dynamic Mechanical Analysis (DMA) Results. To further characterize the mechanical performance of the coatings, dynamic mechanical analysis (DMA) was used to determine the glass transition temperature (Tg) and estimate the crosslink density of the cured films. Tg values were obtained from the peak of the tan 6 curve, while crosslink density was calculated using the rubber elasticity theory based on the storage modulus in the high-temperature plateau region.

The crosslink density (ve) was calculated using the formula:

$$ve = {E}^{′} / ( 3 RT ) ,$$

wherein:
E′ is the storage modulus in the rubbery plateau (Pa),
R is the universal gas constant (8.314 J/mol-K), and
T is the absolute temperature in Kelvin.

Using this method, the control coating exhibited a storage modulus of 1.20e+07 Pa, corresponding to a crosslink density of 1.61e+03 mol/m³. In comparison, the formulation containing LFPCL-1 showed a slightly lower modulus of 1.00e+07 Pa, resulting in a crosslink density of 1.35e+03 mol/m³.

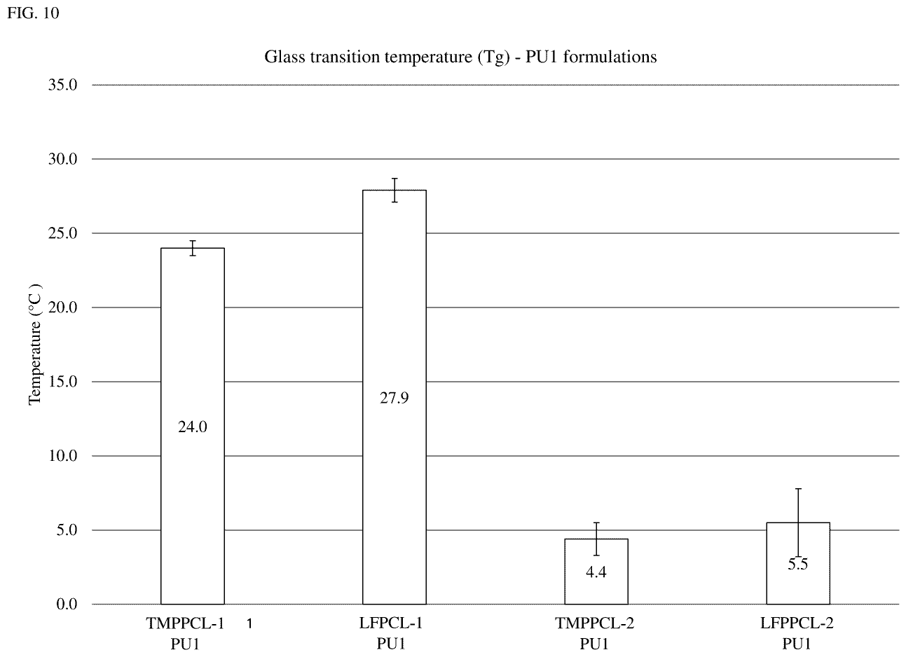

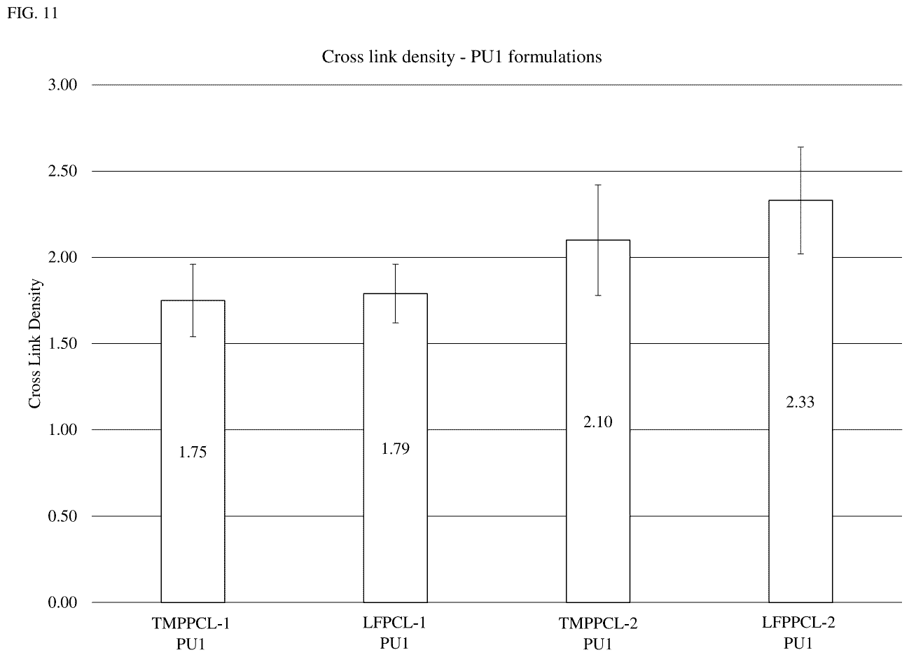

TMPPCL-1 PU1 and LFPCL-1 PU1 show similar Tg and crosslink density, indicating comparable viscoelastic, mechanical, and thermal properties between the two 300MW polyols (FIGS. 10 and 11). Likewise, TMPPCL-2 PU1 and LFPCL-2 PU1 exhibit similar behaviour, suggesting consistent mechanical and thermal performance between the two 500MW polyols (FIGS. 10 and 11).

Discussion of Results. To address the need for alternative materials to replace TMP-based polycaprolactone triols, newly developed 300 molecular weight and a 500 molecular weight label-free, polycaprolactone triols were evaluated within a solvent-borne 2K polyurethane formulation and compared to alternative polyols. The polycaprolactone triols of the present disclosure are safer to use and offer improved handling, easier processing and will aid in reducing volatile organic compounds (VOCs) within a coating.

Pot-life and dry time determination is comparable to the benchmark/comparative polyols, with the added benefit of extending pot life and shortening dry time by increasing the amount of the TMP-free polycaprolactone triols of the present disclosure in the formulation. Physical testing of the polyurethane formulations shows that the polycaprolactone triols of the present disclosure have gloss values, flexibility, crosshatch adhesion, impact resistance, abrasion resistance, chemical resistance, stain resistance, pendulum hardness, and mechanical and thermal properties that are comparable with the benchmark/comparative polyols. The addition of the TMP-free polycaprolactone triols of the present disclosure improves the scratch resistance of the coating and the self-heal properties of the coating. The polycaprolactone triols of the present disclosure will be essential in developing coatings that are both effective and safe for users and the environment.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

Thus, those skilled in the art will recognize, or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A two-component thermoset polyurethane comprising one or more polycaprolactone comprising (i) one or more unsubstituted or substitute caprolactone monomers, and (ii) an initiator comprising at least one primary hydroxyl group and at least one secondary hydroxyl group, wherein the polycaprolactone has an average molecular weight of about 240 g/mol to about 10,000 g/mol.

2. A two-component thermoset polyurethane comprising one or more polycaprolactone comprising (i) three caprolactone polymers attached to (ii) an initiator comprising at least one primary hydroxyl group and at least one secondary hydroxyl group, wherein each of the three caprolactone polymers is independently comprising one or more unsubstituted or substitute caprolactone monomers.

3. The two-component thermoset polyurethane of claim 2, wherein:
the three caprolactone polymers are attached to the initiator via an oxygen of the initiator; or
the polycaprolactone has the chemical structure: 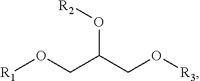
wherein each of R1, R2, and R3 are independently a caprolactone polymers is independently comprising one or more unsubstituted or substitute caprolactone monomers.

4. A two-component thermoset polyurethane comprising a polycaprolactone composition comprising a polycaprolactone comprising a reaction product of (i) one or more unsubstituted or substitute caprolactone monomer, and (ii) an initiator comprising at least one primary hydroxyl group and at least one secondary hydroxyl group, wherein
the one or more caprolactone monomer is present in the range of about 5.0 wt % to about 99.0 wt % of the total molecular weight of the polycaprolactone composition,
the initiator is present in the range of about 1.0 wt % to about 95.0 wt % of the total molecular weight of the polycaprolactone composition, and
the polycaprolactone has an average molecular weight of about 240 g/mol to about 10,000 g/mol.

5. The two-component thermoset polyurethane of claim 1, wherein at least one of:
the initiator comprises two primary hydroxyl groups;
the initiator comprises one secondary hydroxyl group;
the initiator is a trifunctional initiator;
the initiator is at least one of glycerol, glucose, sucrose, fructose, or a combination thereof;
the polycaprolactone has an average molecular weight of about 240 g/mol to about 5,000 g/mol or about 300 g/mol to about 5,000 g/mol; or
a combination thereof.

6. The two-component thermoset polyurethane composition of claim 1, wherein the two-component thermoset polyurethane composition comprises a reaction product of:
(a) the one or more polycaprolactone or polycaprolactone composition that is present in the range of about 5.0 wt % to about 95.0 wt % of the two-component thermoset polyurethane composition, wherein the one or more polycaprolactone composition or polycaprolactone has an average molecular weight of about 240 g/mol to about 10,000 g/mol;
(b) one or more polyisocyanate comprising two or more isocyanate groups that is present in the range of about 5.0 wt % to about 95.0 wt % of the two-component thermoset polyurethane composition;
(c) optionally one or more additional polyol that is present in the range of about 0.0 wt % to about 90.0 wt % of the two-component thermoset polyurethane composition; and
(d) optionally one or more chain extender, wherein the one or more chain extender comprises at least one of one or more diol chain extender, one or more diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition.

7. The two-component thermoset polyurethane composition of claim 6, wherein:
a first composition comprises the one or more polycaprolactone or polycaprolactone composition, the optionally one or more additional polyol, and the optionally one or more chain extender; and
a second composition comprises the one or more polyisocyanate,
wherein the first composition and second composition are combined or mixed to form the reaction product.

8. The two-component thermoset polyurethane composition of claim 1, wherein the two-component thermoset polyurethane composition comprises a reaction product of:
(a) a polyol resin that is present in the range of about 5.0 wt % to about 95.0 wt % of the two-component thermoset polyurethane composition, wherein the polyol resin comprises the one or more polycaprolactone or polycaprolactone composition and a resin, wherein the one or more polycaprolactone composition or polycaprolactone has an average molecular weight of about 240 g/mol to about 10,000 g/mol, and a ratio of resin to one or more polycaprolactone or polycaprolactone composition is about 70:30 to about 95:5;
(b) one or more polyisocyanate comprising two or more isocyanate groups that is present in the range of about 5.0 wt % to about 95.0 wt % of the two-component thermoset polyurethane composition;
(c) optionally one or more additional polyol that is present in the range of about 0.0 wt % to about 90.0 wt % of the two-component thermoset polyurethane composition; and
(d) optionally one or more chain extender, wherein the one or more chain extender comprises at least one of one or more diol chain extender, one or more diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the two-component thermoset polyurethane composition.

9. The two-component thermoset polyurethane composition of claim 8, wherein:
a first composition comprising the polyol resin, the optionally one or more additional polyol, and the optionally one or more chain extender; and
a second composition comprising the one or more polyisocyanate,
wherein the first composition and second composition are combined or mixed to form the reaction product.

10. The two-component thermoset polyurethane composition of claim 6, wherein at least one of:
the one or more polyisocyanate is one or more diisocyanate, comprising 4,4′-diphenylmethane diisocyanate, isophorone diisocyanate, bimethylene diisocyanate, trimethylene diisocyanate, 1,3-trimethylene diisocyanate, 2,3-trimethylene diisocyanate, 1,2-trimethylene diisocyanate, 2,2-trimethylene diisocyanate, tetramethylene diisocyanate, 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, pentamethylene diisocyanate, 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, hexamethylene diisocyanate, 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, heptamethylene diisocyanate, 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, toluene diisocyanate, toluene-2,4-diisocyanate, toluene-2,6-diisocyanate, naphthylene diisocyanate, 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, cyclohexylmethane diisocyanate, 1,4-cyclohexylmethane diisocyanate, 2,4-cyclohexylmethane diisocyanate, 3,4-cyclohexylmethane diisocyanate, 4,4-cyclohexylmethane diisocyanate, dicyclohexylmethane diisocyanate, 4,4′-dicyclohexylmethane diisocyanate, 1,4-dicyclohexylmethane diisocyanate, or a mixture thereof;
the one or more diol chain extender comprises an aliphatic diol or an aromatic diol;
the one or more diol chain extender comprises an alkylene oxide or glycol, ethylene glycol, propanediol, 1,3-propanediol, 1,2-propanediol, 1,1-propanediol, 2,2-propanediol, butanediol, 1,4-butanediol, 1,3-butanediol, 1,2-butanediol, 2,3-butanediol, 1,1-butanediol, 2,2-butanediol, pentadiol, 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, hexanediol, 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, heptadiol,1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, dihydroxybenzene, 1,2-dihydroxybenzene, 1,3-dihydroxybenzene, 1,4-dihydroxybenzene, di(hydroxyethyl)-hydroxyquinone, 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, di(hydroxymethyl)-hydroxyquinone, 2,5-di-(hydroxyethyl)-hydroxyquinone, 2,3-di-(hydroxymethyl)-hydroxyquinone, 3,5-di-(hydroxymethyl)-hydroxyquinone, di-(hydroxyethyl)-bisphenol A, 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A), or a mixture thereof;
the one or more diamine chain extender comprises diaminodiphenylmethane, 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, dichloro-diaminodiphenylmethane, 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane,4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, diaminobenzene, 1,4-diaminobenzene, 1,2-diaminobenzene, 1,3-diaminobenzene, dimethoxy-diamino biphenyl, 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl,4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, dimethyl-diamino biphenyl, 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl,4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3, 5′-diamino biphenyl, 6,6′-dimethyl-4,5′-diamino biphenyl, diamino biphenyl, 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, dichloro-diamino biphenyl, 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl,4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof; or
a mixture thereof.

11. The two-component thermoset polyurethane composition of claim 6, wherein at least one of:
the one or more polycaprolactone or polycaprolactone composition or the polyol resin is present in the range of about 20.0 wt % to about 80.0 wt % of the two-component thermoset polyurethane composition;
the one or more polyisocyanate is present in the range of about 20.0 wt % to about 80.0 wt % of the two-component thermoset polyurethane composition;
the one or more diol chain extender, the one or more diamine chain extender, or the combination thereof, is present in the range of about 0.0 wt % to about 15.0 wt % of the two-component thermoset polyurethane composition; or
a combination thereof.

12. The two-component thermoset polyurethane composition of claim 6, wherein at least one of:
the one or more polycaprolactone or polycaprolactone composition or the polyol resin is present in the range of about 5.0 wt % to about 80.0 wt % of the two-component thermoset polyurethane composition;
the one or more additional polyol is present in the range of up to about 75.0 wt % of the two-component thermoset polyurethane composition;
the combination of the one or more polycaprolactone position and the one or more additional polyol is present in the range of about 20.0 wt % to about 80.0 wt % of the two-component thermoset polyurethane composition;
the one or more polyisocyanate is present in the range of about 20.0 wt % to about 80.0 wt % of the two-component thermoset polyurethane composition;
the one or more diol chain extender, the one or more diamine chain extender, or the combination thereof, is present in the range of about 0.0 wt % to about 15.0 wt % of the two-component thermoset polyurethane composition; or
a combination thereof.

13. The two-component thermoset polyurethane composition of claim 6, wherein the two-component thermoset polyurethane composition is prepared by a process comprising reacting the one or more polycaprolactone composition, the one or more polyisocyanate, and optionally, the one or more chain extender.

14. A method of making or producing the two-component thermoset polyurethane composition of claim 6, the method comprising reacting the one or more polycaprolactone or polycaprolactone composition or the polyol resin, the one or more polyisocyanate, optionally the one or more additional polyol, and optionally the one or more chain extender.

15. The two-component thermoset polyurethane composition of claim 1 made by a process comprising reacting:
the one or more polycaprolactone or polycaprolactone composition or the polyol resin;
optionally, one or more additional polyol;
one or more polyisocyanate comprising two or more isocyanate groups;
optionally, one or more defoamer;
optionally, one or more surface additive;
optionally, one or more solvent; and
one or more catalyst,
thereby forming a two-component thermoset polyurethane material or composition.

16. The two-component thermoset polyurethane of claim 15, wherein:
a first composition comprising the one or more polycaprolactone or polycaprolactone composition or the polyol resin, optionally the one or more additional polyol, optionally the one or more defoamer, optionally the one or more surface additive, optionally the one or more chain extender, optionally the one or more solvent, and the one or more catalyst;
a second composition comprising the one or more polyisocyanate and optionally the one or more solvent; and
the process further comprises combining or mixing the first composition and the second composition, thereby forming the two-component thermoset polyurethane material or composition.

17. The two-component thermoset polyurethane composition of claim 15, wherein the process further comprises adding to, and/or combining or mixing with, the the one or more polycaprolactone or polycaprolactone composition or the polyol resin, the optionally one or more additional polyol, optionally the one or more defoamer, optionally the one or more surface additive, optionally the one or more chain extender, optionally the one or more solvent, and the one or more catalyst:
optionally, one or more cosolvent; and
one or more aliphatic polyisocyanate,
thereby forming a two-component thermoset polyurethane material or composition.

18. The two-component thermoset polyurethane composition of claim 17, wherein at least one of: optionally the one or more cosolvent is present in the first composition, optionally the one or more cosolvent is present in the second composition, the one or more aliphatic polyisocyanate is present in the second composition, the one or more polyisocyanate is the one or more aliphatic polyisocyanate, or a combination thereof.

19. A method of making or producing the two-component thermoset polyurethane composition of claim 15, the method comprising reacting:
the one or more polycaprolactone or polycaprolactone composition or the polyol resin;
optionally, one or more additional polyol;
one or more polyisocyanate comprising two or more isocyanate groups;
optionally, one or more defoamer;
optionally, one or more surface additive;
optionally, one or more solvent; and
one or more catalyst,
thereby forming a two-component thermoset polyurethane material or composition.

20. The method of claim 19, wherein:
a first composition comprises the one or more polycaprolactone or polycaprolactone composition or the polyol resin, optionally the one or more additional polyol, optionally the one or more defoamer, optionally the one or more surface additive, optionally the one or more solvent, and the one or more catalyst;
a second composition comprises the one or more polyisocyanate and optionally the one or more solvent; and
the method further comprises combining or mixing the first composition and the second composition, thereby forming the two-component polyurethane material or composition.

21. A polyurethane dispersion in aqueous or organic media, a two-component polyurethane coating, or a two-component polyurethane sealant, comprising the two-component thermoset polyurethane composition of claim 1.
